(19) United States
(12) Patent Application Publication
(10) Pub. No.: US 2026/0200608 A1
(43) Pub. Date: Jul. 16, 2026

(54) Rotatable External Cage for Vehicle

(71) Applicant: The Johns Hopkins University, Baltimore, MD (US)

(72) Inventors: Richard A. Startt, Taneytown, MD (US); Da Xu, Fulton, MD (US); Michael K. Qin, Arlington, VA (US); Nicholas J. Zielinski, Baltimore, MD (US); Garrett M. Krol, Baltimore, MD (US); William R. Setzler, Severn, MD (US)

(21) Appl. No.: 19/136,803

(22) PCT Filed: Sep. 7, 2023
(86) PCT No.: PCT/US2023/073628

§ 371 Date: Jun. 6, 2025

Related U.S. Application Data
(60) Provisional application No. 63/476,455, filed on Dec. 21, 2022.

(51) Int. Cl. B64U 20/30; B64C 17/06; B64U 10/14; B64U 20/80; B64U 50/30; B64U 60/60

(52) U.S. Cl. CPC B64U 20/30; B64C 17/06; B64U 10/14; B64U 20/80; B64U 50/30; B64U 60/60

(57) ABSTRACT

An vehicle, such as an aerial vehicle, may include a propulsion platform and a barrier assembly. The barrier assembly may include an external cage and a gimbal assembly. The propulsion platform may include a controllable motor and a propeller operably coupled to the motor. The external cage may be operably coupled to the propulsion platform, and the external cage may be constructed with a plurality of rods connected by a plurality of vertex connectors. The propulsion platform may be disposed within the external cage. The gimbal assembly may operably couple the propulsion platform to the external cage thereby securing the propulsion platform to the external cage while enabling relative rotational movement between the aeronautic platform and the external cage about at least a first axis of rotation.

### CROSS REFERENCE TO RELATED APPLICATIONS

This application is a U.S. national stage under 35 U.S.C. § 371 of International Application No. PCT/US2023/073628, filed Sep. 7, 2023, entitled “Rotatable External Cage for Vehicles,” which claims the benefit of U.S. Provisional Application No. 63/476,455, filed Dec. 21, 2022, the contents of each are incorporated by reference herein in their entirety.

### STATEMENT OF GOVERNMENTAL INTEREST

This invention was made with Government support under contract number N00024-13-D-6400 awarded by Naval Sea Systems Command. The Government has certain rights in the invention.

### TECHNICAL FIELD

Exemplary embodiments generally relate to mechanical protection barriers, and more specifically relate to external protection systems for moving vehicles such as aerial vehicles.

### BACKGROUND

Aerial drones and unmanned aerial vehicles (UAVs) have proven to be very useful and effective at a wide variety of tasks. UAVs are excellent platforms for aerial survey and reconnaissance applications where the environment in which the UAV will operate may be unknown. Additionally, in some instances, the UAVs performing such tasks may be required to traverse environments that are densely populated with dynamic obstacles. Such environments may be dense forest, highly populated urban or indoor environments. Additionally, for example, UAVs are now frequently employed in autonomous swarming applications that involve cooperative movements of many UAVs, often in close proximity of each other, such that active de-confliction between each UAV is required to minimize potential UAV-to-UAV collisions. Lastly, recent applications in both the commercial and military domains are driving the need to operate UAVs in close proximity of humans without inflicting injury (e.g. automated package delivery in urban environment, specialized UAV training in military exercises).

As sensing technologies and computational power of processors improved, the standard approach to enable obstacle avoidance on UAVs utilizes onboard environmental sensors and software algorithms. However, in many situations (e.g. in military applications), the UAV is required to operate in complex hostile environments, where reliable sensing of obstacles and timely avoidance maneuvers may not be achievable due to various factors (e.g., flight speed/altitude, lighting conditions). If an obstacle is not accurately detected or the processing speeds are affected by other procedures, the result can be a collision that causes damage to the propellers and leads to the loss of the UAV. Further, if the UAV falls after a collision, the position of the UAV on the ground (e.g., upside down) may inhibit its ability to return to flight, even when the UAV has sustained little or no damage from the collision.

As such, there continues to be a need to develop solutions for UAVs and other vehicles to address collision risks with obstacles in the vehicle's environment and also recover to flight when a vehicle falls or is otherwise positioned on the ground in a compromised orientation.

### BRIEF SUMMARY OF SOME EXAMPLES

According to some example embodiments, an aerial vehicle is provided. The aerial vehicle may comprise an aeronautic platform, an external cage, and a gimbal assembly. The aeronautic platform may comprise a body, a motor supported by the body, and an aeronautic propeller operably coupled to the motor. The motor may be controllable to control rotation of the propeller. The external cage may be operably coupled to the aeronautic platform, and the external cage may comprise a plurality of rods connected by a plurality of vertex connectors. The aeronautic platform may be disposed within the external cage. The gimbal assembly may operably couple the aeronautic platform to the external cage thereby securing the aeronautic platform to the external cage while enabling relative rotational movement between the aeronautic platform and the external cage about a first axis of rotation.

According to some example embodiments, a barrier assembly for suspending a propulsion platform therein is provided. The barrier assembly may be freely rotatable relative to the propulsion platform about at least a first axis of rotation. The barrier assembly may comprise a plurality of rods, a plurality of vertex connectors, and a gimbal assembly. The plurality of rods may be connected by the plurality of vertex connectors to form an external cage having a shape. The external cage may be configured to maintain the propulsion platform within an internal volume of the external cage. The gimbal assembly may be configured to operably couple the external cage to the propulsion platform in a secured position while enabling relative rotational movement between the propulsion platform and the external cage about the first axis of rotation.

According to some example embodiments, a vehicle is provided. The vehicle may comprise a propulsion platform, an external cage, and a gimbal assembly. The propulsion platform may comprise a body, a motor supported by the body, and a propeller operably coupled to the motor. The motor may be controllable to control rotation of the propeller. The external cage may be operably coupled to the propulsion platform, and the external cage may comprise a plurality of rods connected by a plurality of vertex connectors. The propulsion platform may be disposed within the external cage. The gimbal assembly may operably couple the aeronautic platform to the external cage thereby securing the propulsion platform to the external cage while enabling relative rotational movement between the propulsion platform and the external cage about a first axis of rotation, a second axis of rotation, and a third axis of rotation. The first axis of rotation, the second axis of rotation, and the third axis of rotation may each be perpendicular to each other.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1A illustrates an aeronautic platform according to some example embodiments;

FIG. 1B illustrates an external cage according to some example embodiments;

FIG. 1C illustrates an aerial vehicle comprising an aeronautic platform, an external cage, and an single axis gimbal assembly according to some example embodiments;

FIG. 1D illustrates an aerial vehicle comprising an aeronautic platform, an external cage, and a two axis gimbal assembly according to some example embodiments;

FIG. 1E illustrates an aerial vehicle comprising an aeronautic platform, an external cage, and a three axis gimbal assembly according to some example embodiments;

FIG. 2A illustrates a perspective view of a vehicle comprising a propulsion platform, an external cage, and a three axis gimbal assembly according to some example embodiments;

FIG. 2B illustrates a side view of a vehicle comprising a propulsion platform, an external cage, and a three axis gimbal assembly according to some example embodiments;

FIG. 3A illustrates a perspective top view of a propulsion platform according to some example embodiments;

FIG. 3B illustrates a first side view a propulsion platform according to some example embodiments;

FIG. 3C illustrates a second side view a propulsion platform according to some example embodiments;

FIG. 4A illustrates a perspective side view of another propulsion platform according to some example embodiments;

FIG. 4B illustrates a side view of another propulsion platform according to some example embodiments;

FIG. 4C illustrates a top view of another propulsion platform according to some example embodiments;

FIG. 4D illustrates a bottom view of another propulsion platform according to some example embodiments;

FIG. 5A illustrates an external cage according to some example embodiments;

FIG. 5B illustrates an external cage highlighting a construction pattern according to some example embodiments;

FIG. 5C illustrates another external cage according to some example embodiments;

FIG. 5D illustrates another external cage comprising an access opening according to some example embodiments;

FIG. 6A illustrates components of a single axis gimbal assembly according to some example embodiments;

FIG. 6B illustrates components of a single axis gimbal assembly comprising a cage hub according to some example embodiments;

FIG. 7A illustrates a first perspective view of components of a two axis gimbal assembly according to some example embodiments;

FIG. 7B illustrates a second perspective view of components of a two axis gimbal assembly according to some example embodiments;

FIG. 8A illustrates a first perspective view of components of a three axis gimbal assembly according to some example embodiments;

FIG. 8B illustrates a second perspective view of components of a three axis gimbal assembly according to some example embodiments;

FIG. 8C illustrates a side view of components of a three axis gimbal assembly according to some example embodiments;

FIG. 9A illustrates an exploded view of a suspension hub according to some example embodiments;

FIG. 9B illustrates a perspective top view of a suspension hub according to some example embodiments;

FIG. 9C illustrates a perspective top view of a suspension hub with a rotating member having rotated forty-five degrees relative to FIG. 9B according to some example embodiments;

FIG. 9D illustrates a top view of a suspension hub with a rotating member having rotated forty-five degrees relative to FIG. 9B and defining a cross-section A-A according to some example embodiments;

FIG. 9E illustrates a perspective cross-section view of the suspension hub of FIG. 9D with the cross-section taken at A-A of FIG. 9D according to some example embodiments;

FIG. 10A illustrates a perspective top view of an assembly comprising a propulsion platform and a three axis gimbal assembly according to some example embodiments; and

FIG. 10B illustrates a side view of an assembly comprising a propulsion platform and a three axis gimbal assembly according to some example embodiments.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. As provided herein, the term “or” is intended to have the meaning of the logical “or” operator (in contrast to the exclusive “or” operator) such that A or B means that A is an option, B is an option, and A and B together are an option.

According to some example embodiments, a technical solution to the issues raised above may involve the implementation of a barrier assembly comprising a gimbaled external cage for an unmanned aerial vehicle (UAV) or the like that surrounds the UAV to form a freely rotating physical barrier that protects the UAV from collisions and maintains an orientation of the UAV relative to the ground. According to some example embodiments, the external cage may be any shape, but according to some example embodiments, the external cage may be generally spherical in shape. The external cage may define an internal volume within which an aeronautic platform, which may be a UAV or the like, may be positioned. According to some example embodiments, an architecture of the external cage may include a pattern of polygons, such as pentagons and hexagons (e.g., in the form of a Buckyball, a carbon 60 molecule, or the like). The external cage may be constructed of rods and vertex connectors to form a shape that generally surrounds the aeronautic platform. According to some example embodiments, the configuration of the rods and vertex connectors may have a relatively small surface area to reduce the effect on air flow through the external cage, but also operate as an external barrier for the aeronautic platform. Additionally, the external cage may be constructed of light-weight materials to minimize the impact on the operation of an aeronautic platform. Further, according to some example embodiments, the external cage may have sufficient structural integrity to withstand an impact, but also have some degree of flexibility to temporarily flex or deform to absorb at least some force of an impact. Further, the external cage may also have sufficient structural integrity to support the weight of the aeronautic platform when positioned on the ground. Because the aeronautic platform is disposed within the internal volume of the external cage, the aeronautic platform and, for example, the propellers, may be protected from impacts with blunt obstacles which impact the external cage without otherwise contacting the aeronautic platform or the more sensitive components, such as the propellers.

Additionally, according to some example embodiments, the aeronautic platform may be coupled to the external cage via a gimbal assembly. The gimbal assembly may, according to some example embodiments, enable rotation of the external cage relative to the aeronautic platform relative to one, two, three, or more axes. The external cage may therefore be configured to rotate around the aeronautic platform via operation of the gimbal assembly and the aeronautic platform may be configured to rotate within the external cage. According to some example embodiments, the external cage may be free to rotate relative to the aeronautic platform, and, as such, the axles of the gimbal assembly need not be driven axles to force relative movement of the external cage 250. Rather, the axles of the gimbal assembly may be free to rotate in response to forces external to the cage, such as air flow, an impact, or the like. Because the gimbal assembly is passive and not driven, the axles of the gimbal assembly may be referred to as dead axles or undriven axles. Such free rotation of the external cage may support the external cage's ability to sustain a collision and absorb a torque or moment of inertia that would have otherwise been experienced by the aeronautic platform. Also, the free rotation of the external cage may generate by-product air currents (e.g., eddy currents) during flight due to spinning motion of the external cage, the aerodynamic properties of the external cage, and environmental factors such as wind. These by-product air currents may induce a repelling force around portions of the external cage that may further reduce the risk and force of collisions, for example, with other aerial vehicles that may be operating in close proximity (e.g. in a swarm application). Also, since the external cage may prevent the aeronautic platform from directly contacting the ground, the aeronautic platform may move along the ground, in a rolling fashion, on the external cage via low altitude flight that causes the external cage to contact the ground. The maneuverability of such a rolling implementation may be dependent upon the number of axes of rotation that gimbal assembly enables (e.g., one, two, three, etc.).

Additionally, according to some example embodiments, the axes of rotation of the gimbal assembly may be positioned relative to a weight distribution of the aeronautic platform such that a bottom side of the aeronautic platform is maintained closest to the ground when no propulsion of the aeronautic platform is otherwise moving the aeronautic platform out of this orientation. As such, since the aeronautic platform may be free to rotate within the external cage, the positioning of the axes of rotation in this manner can cause the aeronautic platform to “right” itself due to the vector force of the aeronautic platform's weight. As such, the aeronautic platform may be positioned in an orientation that enables the aeronautic platform to return to flight without external intervention since the orientation of the aeronautic platform is maintained within the external cage.

While example embodiments described herein are described with respect to aerial vehicles, it is understood that example embodiments may be implemented in other contexts with similar results. For example, rather than an aeronautic platform, an aquatic platform may be utilized for implementation of a barrier assembly comprising an external cage and a gimbal assembly in an underwater implementation. In such example embodiments intended for underwater usage, propulsion of the aquatic platform may be performed via aquatic propellers, aquatic jets, and other aquatic propulsion devices. Further, according to some example embodiments, the aeronautic platform may alternatively be a space flight platform, and example embodiments may be implemented in the context of space environments. Regardless of the medium or environment that is intend for implementation of the platform or vehicle, according to some example embodiments, alternative propulsion devices may be used in place of propellers, such as, for example, impellers, jet engines, thrusters (e.g., ion thrusters, Hall-effect thrusters, etc.), propulsive nozzles, ramjets, rocket engines, or any other propulsion device capable of generating a force to cause movement of a vehicle through a medium or in a vacuum.

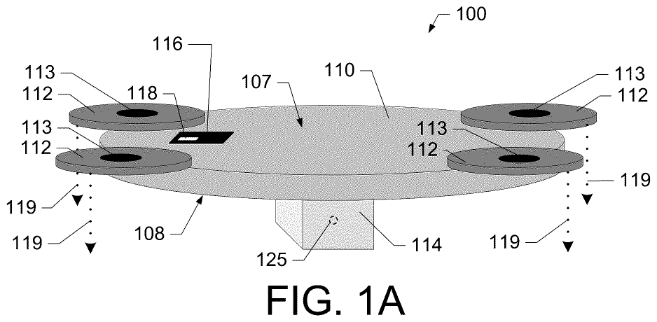

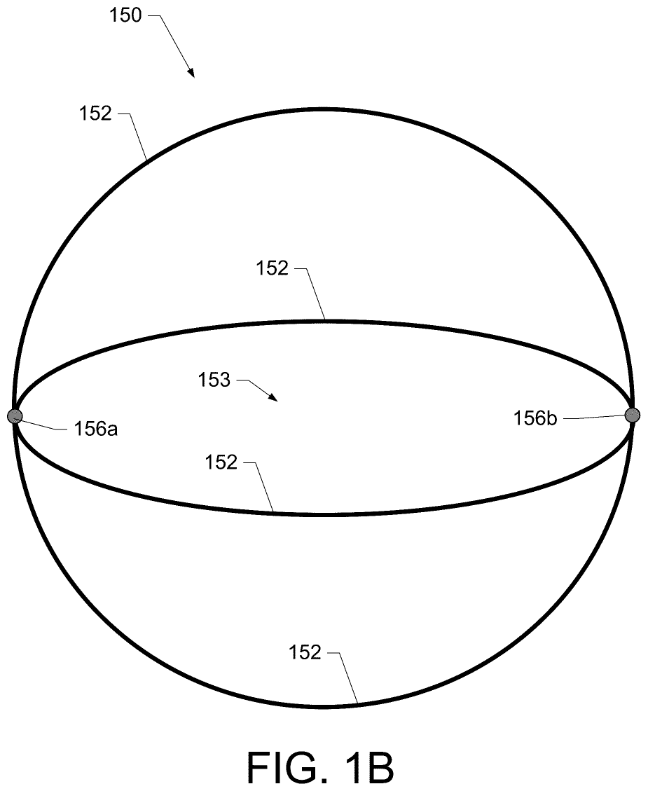

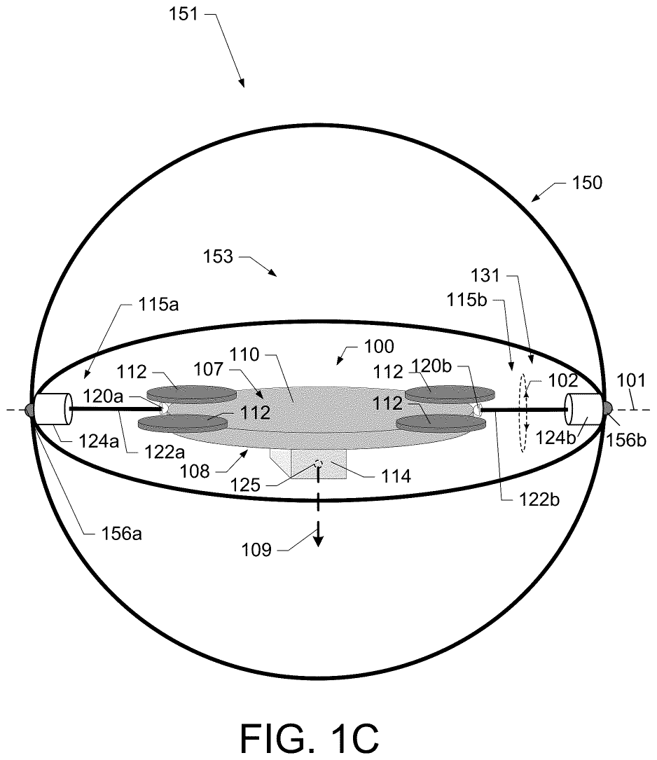

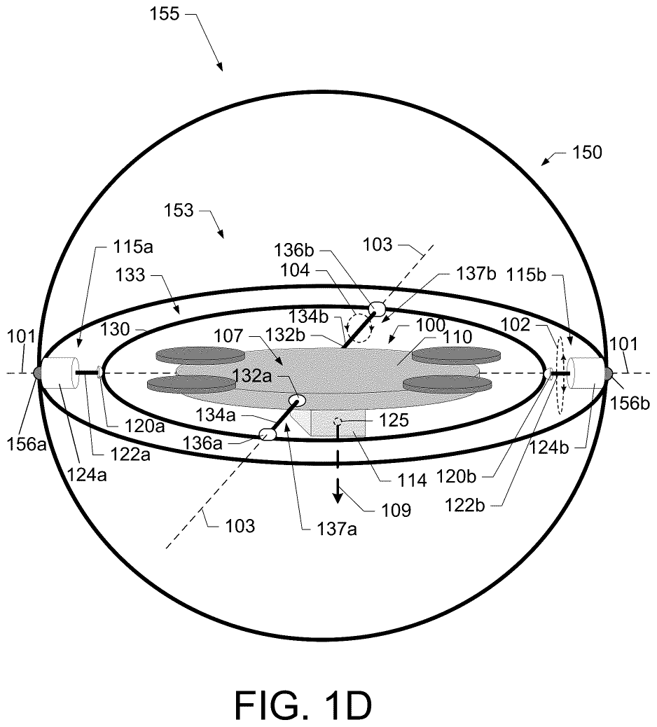

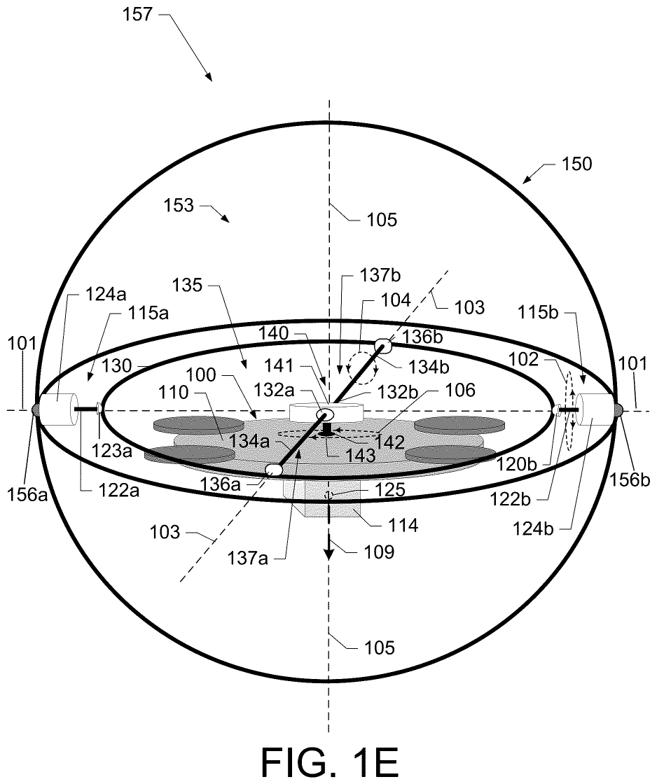

Having described aspects of some example embodiments in a general sense, reference is now made to FIG. 1A, which illustrates an example propulsion platform in the form of an aeronautic platform 100. The aeronautic platform 100 may be an aerial drone, UAV, a specialized propulsion platform, or the like. According to some example embodiments, the aeronautic platform 100 may be specifically designed or the aeronautic platform 100 may be a commercial off-the-shelf (COTS) system. According to some example embodiments, the aeronautic platform 100 may have a plurality of propulsion systems that are coupled to a body 110. The propulsion systems may comprise a propulsion device, such as a propeller 112. Each propeller 112 may be driven by a controllable motor 113 (e.g., an electric motor) to generate, for example, a thrust 119, which for explanation purposes may be directed downward or towards the ground. As such, for flight operation, the aeronautic platform 100 may be oriented such that the thrust generated by the propellers 112 is directed downward to lift the aeronautic platform 100 from the ground. Control circuitry 116 may include a processor, memory, and other active and passive components to control operation of the motors 113 to cause the aeronautic platform 100 to maneuver in flight. Via independent control of each motor 113, the control circuitry 116 may be control the aeronautic platform 100 to hover, spin, move in a direction, descend, etc. The processor may be embodied as a microprocessor that executes software or firmware stored in a memory, such as a non-volatile memory. Alternatively, the processor may be hardware configured as, for example, a field programmable gate array (FPGA), an application specific integrated circuit (ASIC), or the like. As a result, the processor may be configured to perform controlled movement of the aeronautic platform 100 by controlling the operation of the motors 113. According to some example embodiments, the aeronautic platform 100 may comprise multiple (e.g., four) propellers 112 and respective motors 113, and the aeronautic platform 100 may be operated, for example, in a quad-copter configuration.

To assist with navigation, particularly in autonomous navigation applications, the control circuitry 116 may include a position sensor 118. The position sensor 118 may be, for example, a global positioning system (GPS) component. The position sensor 118 may be a stand-alone component or the position sensor 118 may be a component of a combined package that includes, for example, an accelerometer, a gyroscope, an altimeter, or the like. Alternatively, the control circuitry 116 may include one or more components comprising an accelerometer, a gyroscope, altimeter, or the like. According to some example embodiments, the position sensor 118, as a GPS component, may be configured to receive signals from orbiting satellites to determine a position of the aeronautic platform 100. Accordingly, a signal receiver of the GPS component may be required to be upward or sky facing in order to receive the satellite signals. For this reason, the GPS receiver may be positioned on a top side 107 of the aeronautic platform 100. If the GPS receiver were to be blocked by other components, such as metal components, receipt of the satellite signals may be inhibited or prevented, which raises the need to have the GPS receiver in a location that has clearance for receiving the satellite signals.

Additionally, according to some example embodiments that are considered within a gravity environment, the aeronautic platform 100 may have a relatively low center of gravity. In this regard, the weight distribution of the aeronautic platform 100 may make the aeronautic platform 100 “bottom heavy” such that the center of gravity is positioned, for example, below a body 110 or closer to a bottom side 108 of the body 110. According to some example embodiments, a high weight, high density component, such as a battery 114 (in some embodiments this could be a fuel cell or other fuel container), may be affixed to the bottom side 108 of the body 110. As such, the weight distribution caused by this placement of the battery 114 may cause the center of gravity 125 to be positioned, for example, below the body 110, as shown.

As further described herein, strategically placing of the center of gravity 125 by considering the weight distribution of the aeronautic platform 100 design relative to the axes of rotation of the gimbal assembly can cause the aeronautic platform 100 to remain in an orientation with the top side 107 facing towards the sky (i.e., away from the ground) to ensure proper orientation for subsequent takeoff for flight and to also ensure that the GPS receiver is properly oriented to receive signals for position determination.

Referring now to FIG. 1B, an example external cage 150 is shown. The external cage 150 comprises a plurality of rods 152 and a plurality of vertex connectors 156 (individually vertex connector 156a and 156b). In this minimalist example embodiment, the external cage 150 comprises four rods 152 and two vertex connectors 156. Each rod 152 is connected to each vertex connector 156 at its ends, and the rods 152 are bent to form circular shapes. Accordingly, the rods 152 may be formed of an elastic material, such as materials that comprise a plastic (e.g., a polyethylene plastic such as a high or low density polyethylene, nylon, acrylic, polycarbonate, polyvinyl chloride, acrylonitrile butadiene styrene, etc.), or the like, and the rods 152 may be linear when isolated. However, according to some example embodiments, the rods 152 may be formed with a permanent bend, and, for example, elasticity may be introduced by the materials used to make the vertex connectors 156 or the structure of the vertex connectors 156. In this regard, the vertex connectors 156 may be formed of a flexible material, such as a thermoplastic polyurethane (TPU), a rubber, or the like, that enables pivoting of the rods 152 at the connection points with the vertex connector 156.

According to some example embodiments, the configuration of the rods 152 and the vertex connectors 156 may form a generally spherical shape and define an internal volume 153. According to some example embodiments, the rods 152 may be fixed into the vertex connectors 156 such that the rods 152 maintain their circular shapes. The minimalist example embodiment of the external cage 150 allows for ease of description and understanding without additional rods 152 and vertex connectors 156 obscuring the view of the internal volume 153. However, as further described below, example embodiments of an external cage may have any number of rods 152 and vertex connectors 156, at various positions, to further define, for example, different shapes of the external cage. The rods 152 and vertex connectors 156 are shown in an assembled configuration. However, according to some example embodiments, some or all of the rods 152 may be removable from the vertex connectors 156 to enable disassembly of some or all of the external cage 150, and subsequent reassembly of the external cage 150 by reconnecting the rods 152 to the vertex connectors 156. Such disassembly may enable storage of the external cage 150 in a smaller volume, maintenance of external cage 150 components, or replacement of external cage 150 components.

Now referring to FIG. 1C, a vehicle embodied as aerial vehicle 151 is shown that comprises the aeronautic platform 100, the external cage 150, and a gimbal assembly 131. As shown, the aeronautic platform 100 has been installed within the internal volume 153 of the external cage 150. Further, the aeronautic platform 100 may be operably coupled to the external cage 150 via rotating assemblies of the gimbal assembly 131. According to some example embodiments, the gimbal assembly 131 may be a single-axis gimbal assembly, and therefore relative rotation between the external cage 150 and the aeronautic platform 100 may be about a single axis of rotation 101. In the example embodiment of aerial vehicle 151, the aeronautic platform 100 may be operably coupled to the external cage 150 such that the aeronautic platform 100 may rotate relative to the external cage 150 about the single axis of rotation 101 as indicated by arrows 102.

In this regard, according to some example embodiments, the aeronautic platform 100 may be coupled to the external cage 150 at two positions on the axis of rotation 101. The body 110 of the aeronautic platform 100 may be coupled to the external cage 150 on one side via a first rotating assembly 115a and may be coupled to the external cage 150 on another, opposite side of the body 110 via a second rotating assembly 115b.

The first rotating assembly 115a of the gimbal assembly 131 may comprise a cage hub 124a, an axle 122a, and an inner hub 120a. In general, one or both of the cage hub 124a and the inner hub 120a may enable relative rotation of the axle 122a to thereby enable relative rotation of the external cage 150 with respect to the aeronautic platform 100 about an axis of rotation 101. The axle 122a may be a rotating component that may be configured to rotate with the aeronautic platform 100, rotate with the external cage 150, or rotate relative to both the aeronautic platform 100 and the external cage 150. In this regard, the axle 122a may be rotationally fixed to one of the aeronautic platform 100 or the external cage 150, or the axle 122a may be rotationally fixed to neither the aeronautic platform 100 nor the external cage 150. As an example embodiment, the following describes the axle 122a as being rotationally fixed to the inner hub 120a and the aeronautic platform 100. However, it is understood that some example embodiments may involve the axle 122a being rotationally fixed with the cage hub 124a and rotatable within the inner hub 120a, or the axle 122a may freely rotate relative to both the cage hub 124a and the inner hub 120a.

In this regard, the first cage hub 124a may be operably coupled to or affixed to the external cage 150 at any location. The cage hub 124a may be affixed to the external cage 150 such that the cage hub 124a does not rotate relative to the external cage 150. According to some example embodiments, the cage hub 124a may be affixed to a vertex connector, such as the vertex connector 156a. According to some example embodiments, the cage hub 124a may be integrated with the vertex connector 156a as a singular component. Additionally, the cage hub 124a may be a component that enables the rotation of a shaft, such as the axle 122a within the cage hub 124a. In this regard, the cage hub 124a may comprise an opening that the axle 122a may be received into, and the axle 122a may be rotatable within the opening. According to some example embodiments, the cage hub 124a may comprise additional rotating components, such as a bearing (e.g., a ball bearing) that reduces frictional forces during rotation to enable the axle 122a to rotate more freely.

The axle 122a may be rotationally fixed to the inner hub 120a. The inner hub 120a may, in turn, be rotationally fixed to the body 110. As such, the axle 122a, the inner hub 120a, and the aeronautic platform 100 may, according to some example embodiments, be rotatable as a unit relative to the cage hub 124a and the external cage 150 about the axis of rotation 101.

Similarly, the second rotating assembly 115b of the gimbal assembly 131 may comprise a cage hub 124b, an axle 122b, and an inner hub 120b. In general, one or both of the cage hub 124b and the inner hub 120b may enable relative rotation of the axle 122b to thereby enable relative rotation of the external cage 150 with respect to the aeronautic platform 100 about the axis of rotation 101. The axle 122b may be a rotating component that may be configured to rotate with the aeronautic platform 100, rotate with the external cage 150, or rotate relative to both the aeronautic platform 100 and the external cage 150. In this regard, the axle 122b may be rotationally fixed to one of the aeronautic platform 100 or the external cage 150, or the axle 122b may be rotationally fixed to neither the aeronautic platform 100 nor the external cage 150. As an example embodiment, the following describes the axle 122b as being rotationally fixed to the inner hub 120b and the aeronautic platform 100. However, it is understood that some example embodiments may involve the axle 122b being rotationally affixed to the cage hub 124b and rotatable within the inner hub 120b, or the axle 122b may freely rotate relative to both the cage hub 124b and the inner hub 120b.

In this regard, the cage hub 124b may be operably coupled to or affixed to the external cage 150 at a location that is opposite the location of the cage hub 124a. In this regard, the cage hub 124b may be positioned at a point that is, of example, on a diameter line of the external cage 150 that extends from the cage hub 124a. Similarly, the cage hub 124b may be positioned on the external cage 150 at a location that is furthest from the location of the cage hub 124a. The cage hub 124b may be affixed to the external cage 150 such that the cage hub 124b does not rotate relative to the external cage 150. According to some example embodiments, the cage hub 124b may be affixed to a vertex connector, such as the vertex connector 156b. According to some example embodiments, the cage hub 124b may be integrated with the vertex connector 156b as a singular component. Additionally, the cage hub 124b may be a component that enables the rotation of a shaft or axle 122b within the cage hub 124b. In this regard, the cage hub 124b may comprise an opening that the axle 122b may be received into, and the axle 122b may be rotatable within the opening. According to some example embodiments, the cage hub 124b may comprise additional rotating components, such as a bearing (e.g., a ball bearing) that reduces frictional forces during rotation to enable the axle 122b to rotate more freely.

Similar to the axle 122a, the axle 122b may be rotationally fixed to the inner hub 120b. The inner hub 120b may, in turn, be rotationally fixed to the body 110 or the aeronautic platform 100. As such, the axle 122b, the inner hub 120b, and the aeronautic platform 100 may, according to some example embodiments, be rotatable as a unit relative to the cage hub 124b and the external cage 150 about the axis of rotation 101. As described herein, one of skill in the art would appreciate that other configurations of the rotation-related components may be implemented to enable relative rotation of the aeronautic platform 100 to the external cage 150.

As such, due to the coupling of the first rotating assembly 115a and the second rotating assembly 115b between the aeronautic platform 100 and the external cage 150, the aeronautic platform 100 may be free to rotate about the axis of rotation 101 relative to the external cage 150, according to some example embodiments. According to some example embodiments considered in a gravity environment, the first axis of rotation 101 may be positioned such that the first axis of rotation 101 is within a first plane that includes the center of gravity 125 of the aeronautic platform 100 and bisects the weight of the aeronautic platform 100. The axis of rotation 101 is also positioned on a second plane that is normal to the weight force vector 109 that is directed from the center of gravity 125, where a portion of the aeronautic platform 100 on a side of the of the second plane, that is intended to be directed towards the ground, is heavier than a portion of the aeronautic platform 100 that is intended to be directed towards the sky. As such, the free rotation of the aeronautic platform 100 may result in the top side 107 of the aeronautic platform 100 being directed away from the ground and towards the sky. Positioning of the axis of rotation 101 in this manner causes the aeronautic platform 100 to generally maintain a desired orientation, regardless of any movement or positioning of the external cage 150. As a result, for example, a GPS receiver on the top side 107 may maintain orientation towards the sky to permit satellite signals for GPS positioning to be received. Further, the aeronautic platform 100 may rotate, due to gravity, into an orientation that facilitates returning to flight, regardless of the position of the external cage 150. In this regard, the aeronautic platform 100 may rotate such that the thrust generated by the propellers 112 is directed downward to facilitate flight.

Now referring FIG. 1D, another example vehicle in the form of example aerial vehicle 155 is shown. The aerial vehicle 155 may also comprise the aeronautic platform 100 and the external cage 150. As shown, the aeronautic platform 100 has been installed within the internal volume 153 of the external cage 150. Further, the aeronautic platform 100 may be operably coupled to the external cage 150 via a gimbal assembly 133, which is structured as a two-axis gimbal assembly to enable rotation of the external cage 150 relative to the aeronautic platform 100 with respect to two axes. In the example embodiment of aerial vehicle 155, the aeronautic platform 100 may be operably coupled to the external cage 150 via to the gimbal assembly 133 such that the aeronautic platform 100 may rotate relative to the external cage 150 about a first axis of rotation 101 as indicated by arrows 102 and a second axis of rotation 103 as indicated by arrows 104.

In this regard, according to some example embodiments, the gimbal assembly 133 may comprise a gimbal ring 130. The gimbal ring 130 may be disposed within the internal volume 153 of the external cage 150 and may be interconnected between the external cage 150 and the aeronautic platform 100. In short, the gimbal ring 130 may be rotatable about the first axis of rotation 101 and since the aeronautic platform 100 may be coupled to the gimbal ring 130, the aeronautic platform 100 may be rotatable with the gimbal ring 130 about the first axis of rotation 101. However, the aeronautic platform 100 may also be rotatably coupled to the gimbal ring 130 and therefore the aeronautic platform 100 may also rotate relative to the gimbal ring 130 about the second axis of rotation 103. The gimbal ring 130 may be, for example, circular shaped, however other shapes may also be used (e.g., polygonal, etc.). An interior space of the gimbal ring 130 may define an area that is larger than a dimension of the aeronautic platform 100 to enable the aeronautic platform 100 to rotate within, and relative to, the gimbal ring 130 without contacting the gimbal ring 130. Additionally, the gimbal ring 130 may be sized to be smaller than an inner dimension of the external cage 150 to enable the gimbal ring 130 to rotate within the external cage 150 without contacting the external cage 150. The gimbal ring 130 may be, according to some example embodiments, a rigid member that is unlikely to deform under an applied force or impact on the gimbal ring 130 itself or the external cage 150.

Accordingly, to support two-axis rotation, the gimbal ring 130 may be coupled to the external cage 150 in a similar manner as the aeronautic platform 100 in the single-axis aerial vehicle 151. In this regard, rather than being coupled between the external cage 150 and the aeronautic platform 100, the first rotating assembly 115a may be coupled in the same manner between the external cage 150 and the gimbal ring 130 to support rotation of the gimbal ring 130 about the first axis of rotation 101. As such, the inner hub 120a may be connected to the gimbal ring 130 (as opposed to being connected to the aeronautic platform 100) and the axle 122a may be shortened to extend only to the gimbal ring 130. Similarly, the second rotating assembly 115b may be coupled in the same manner, i.e., between the external cage 150 and the gimbal ring 130 to also support rotation of the gimbal ring 130 about the first axis of rotation 101 and the axle 122b may be shortened to extend only to the gimbal ring 130. Again, the second rotating assembly 115b may be positioned opposite the first rotating assembly 115a such that both rotating assemblies support rotation of the gimbal ring 130 about the first axis of rotation 101 as indicated by the arrows 102. Accordingly, the inner hub 120b may be connected to the gimbal ring 130 rather than the aeronautic platform 100. Other than being connected to the gimbal ring 130, rather than the aeronautic platform 100, and the associated shortening of the axles 120a and 120b, the first rotating assembly 115a and the second rotating assembly 115b may be structured and operate in the same manner as described above for the single-axis aerial vehicle 151.

To support relative rotation about the second axis of rotation 103, the gimbal assembly 133 may further comprise rotating assemblies that are coupled between the gimbal ring 130 and the aeronautic platform 100. In this regard, at positions such that the second axis of rotation 103 may be perpendicular to the first axis of rotation 101, a third rotating assembly 137a may be coupled between the gimbal ring 130 and the aeronautic platform 100, and a fourth rotating assembly 137b may be coupled between the gimbal ring 130 and the aeronautic platform 100.

Similar to the rotating assemblies described above, the third rotating assembly 137a may comprise a ring hub 136a, an axle 134a, and an inner hub 132a. In general, one or both of the ring hub 136a and the inner hub 132a may enable relative rotation of the axle 134a to thereby enable relative rotation of the gimbal ring 130 with respect to the aeronautic platform 100 about the second axis of rotation 103. The axle 134a may be a rotating component that may be configured to rotate with the aeronautic platform 100, rotate with the gimbal ring 130, or rotate relative to both the aeronautic platform 100 and the gimbal ring 130. In this regard, the axle 134a may be rotationally fixed to one of the aeronautic platform 100 or the gimbal ring 130, or the axle 134a may be rotationally fixed to neither the aeronautic platform 100 nor the gimbal ring 130. As an example embodiment, the following describes the axle 134a as being rotationally fixed to the inner hub 132a and the aeronautic platform 100. However, it is understood that some example embodiments may involve the axle 134a being rotationally affixed to the ring hub 136a and rotatable within the inner hub 132a, or the axle 134a may freely rotate relative to both the ring hub 136a and the inner hub 132a.

In this regard, the ring hub 136a may be operably coupled to or affixed to the gimbal ring 130 at any location. However, according to some example embodiments, the ring hub 136a may be positioned on the gimbal ring 130 such that the ring hub 136a is ninety degrees from the inner hub 120a. The ring hub 136a may be affixed to the gimbal ring 130 such that the ring hub 136a does not rotate relative to the gimbal ring 130. The ring hub 136a may be a component that enables the rotation of a shaft, such as the axle 134a within the ring hub 136a. In this regard, the ring hub 136a may comprise an opening that the axle 134a may be received into, and the axle 134a may be rotatable within the opening. According to some example embodiments, the ring hub 136a may comprise additional rotating components, such as a bushing, bearing (e.g., a ball bearing) that reduces frictional forces during rotation to enable the axle 134a to rotate more freely.

The axle 134a may be rotationally fixed to the inner hub 132a. The inner hub 132a may, in turn, be rotationally fixed to the body 110 or the aeronautic platform 100. As such, the axle 134a, the inner hub 132a, and the aeronautic platform 100 may, according to some example embodiments, be rotatable as a unit relative to the ring hub 136a and the gimbal ring 130 about the second axis of rotation 103.

Similarly, according to some example embodiments, the fourth rotating assembly 137b may comprise a ring hub 136b, an axle 134b, and an inner hub 132b. In general, one or both of the ring hub 136b and the inner hub 132b may enable relative rotation of the axle 134b to thereby enable relative rotation of the gimbal ring 130 with respect to the aeronautic platform 100 about the second axis of rotation 103. The axle 134b may be a rotating component that may be configured to rotate with the aeronautic platform 100, rotate with the gimbal ring 130, or rotate relative to both the aeronautic platform 100 and the gimbal ring 130. In this regard, the axle 134b may be rotationally fixed to one of the aeronautic platform 100 or the gimbal ring 130, or the axle 134b may be rotationally fixed to neither the aeronautic platform 100 nor the external cage 150. As an example embodiment, the following describes the axle 134b as being rotationally fixed to the inner hub 132b and the aeronautic platform 100. However, it is understood that some example embodiments may involve the axle 134b being rotationally affixed to the ring hub 136b and rotatable within the inner hub 132b, or the axle 134b may freely rotate relative to both the ring hub 136b and the inner hub 132b.

In this regard, the ring hub 136b may be operably coupled to or affixed to the gimbal ring 130 at any location. However, according to some example embodiments, the ring hub 136b may be positioned on the gimbal ring 130 such that the ring hub 136b is ninety degrees from the inner hub 120b. The ring hub 136b may be affixed to the gimbal ring 130 such that the ring hub 136b does not rotate relative to the gimbal ring 130. The ring hub 136b may be a component that enables the rotation of a shaft, such as the axle 134b within the ring hub 136b. In this regard, the ring hub 136b may comprise an opening that the axle 134b may be received into, and the axle 134b may be rotatable within the opening. According to some example embodiments, the ring hub 136b may comprise additional rotating components, such as a bushing, bearing (e.g., a ball bearing) that reduces frictional forces during rotation to enable the axle 134b to rotate more freely.

The axle 134b may be rotationally fixed to the inner hub 132b. The inner hub 132b may, in turn, be rotationally fixed to the body 110 or the aeronautic platform 100. As such, the axle 134b, the inner hub 132b, and the aeronautic platform 100 may, according to some example embodiments, be rotatable as a unit relative to the ring hub 136b and the gimbal ring 130 about the second axis of rotation 103.

As such, due to the coupling of the first rotating assembly 115a and the second rotating assembly 115b between the gimbal ring 130 and the external cage 150, the gimbal ring 130 and the aeronautic platform 100 may be free to rotate about the first axis of rotation 101 relative to the external cage 150, according to some example embodiments. Further, due to the coupling of the third rotating assembly 137a and the fourth rotating assembly 137b between the gimbal ring 130 and the aeronautic platform 100, the aeronautic platform 100 may be free to rotate about the second axis of rotation 103 relative to the external cage 150, according to some example embodiments. According to some example embodiments, the first axis of rotation 101 and the second axis of rotation 103 may be perpendicular to each other, but the first axis of rotation 101 and the second axis of rotation 103 need not pass through the center of gravity 125 of the aeronautic platform 100.

As such, due to the coupling of the first rotating assembly 115a and the second rotating assembly 115b between the gimbal ring 130 and the external cage 150, and the third rotating assembly 137a and the fourth rotating assembly 137b being coupled between the gimbal ring 130 and the aeronautic platform 100, the external cage 150 may be free to rotate about the first axis of rotation 101 and second axis of rotation 103 relative to the aeronautic platform 100. According to some example embodiments, the first axis of rotation 101 may be positioned such that the first axis of rotation 101 is within a first plane that includes the center of gravity 125 and bisects the weight of the aeronautic platform 100. The first axis of rotation 101 is also positioned on a second plane that is normal to the weight force vector 109 directed from the center of gravity 125, where a portion of the aeronautic platform 100 on a side of the of the second plane that is intended to be directed towards the ground, in a gravity environment, is heavier than a portion of the aeronautic platform 100 that is intended to be directed towards the sky. Additionally, the second axis of rotation 103 may be positioned such that the second axis of rotation 103 is within a third plane that includes the center of gravity 125, is perpendicular to the first plane, and also bisects the weight of the aeronautic platform 100. The second axis of rotation 103 may also be positioned on the second plane (indicated above) that is normal to the weight force vector 109 directed from the center of gravity 125, where a portion of the aeronautic platform 100 on a side of the of the second plane that is intended to be directed towards the ground is heavier than a portion of the aeronautic platform 100 that is intended to be directed towards the sky. As such, the free rotation of the aeronautic platform 100 about the first axis of rotation 101 and the second axis of rotation 103 may result in the top side 107 of the aeronautic platform 100 being directed away from the ground and towards the sky. Positioning of the axis of rotation 101 and the axis of rotation 103 in this manner may cause the aeronautic platform 100 to generally maintain a desirable orientation, regardless of any movement or positioning of the external cage 150. As a result, a GPS receiver on the top side 107 may maintain orientation towards the sky to permit satellite signals for GPS positioning to be received. Further, the aeronautic platform 100 may rotate, due to gravity, into an orientation that facilitates returning to flight (e.g., positions the thrust direction of the propellers toward the ground), regardless of the position of the external cage 150. In this regard, the aeronautic platform 100 may rotate such that the thrust generated by the propellers 112 is directed downward to facilitate flight.

Now referring to FIG. 1E, another example vehicle in the form of example aerial vehicle 157 is shown. The aerial vehicle 157 may also comprise the aeronautic platform 100 and the external cage 150. As shown, the aeronautic platform 100 has been installed within the internal volume 153 of the external cage 150. Further, the aeronautic platform 100 may be operably coupled to the external cage 150 via a gimbal assembly 135, which is structured as a three-axis gimbal assembly to enable rotation of the external cage 150 relative to the aeronautic platform 100 with respect to three axes. In the example embodiment of aerial vehicle 157, the aeronautic platform 100 is operably coupled to the external cage 150 via to the gimbal assembly 135 such that the aeronautic platform 100 may rotate relative to the external cage 150 about a first axis of rotation 101 as indicated by arrows 102, a second axis of rotation 103 as indicated by arrows 104, and a third axis of rotation 105 as indicated by arrows 106.

In this regard, according to some example embodiments, the gimbal assembly 135 may comprise the gimbal ring 130 that supports rotation about the second axis of rotation 103 and a suspension hub 141 that may embody a component of a fifth rotating assembly 140 and supports rotation of about the third axis of rotation 105. As described above, the first rotating assembly 115a and the second rotating assembly 115b may be coupled between the external cage 150 and the gimbal ring 130 to enable relative rotation about the first axis of rotation 101. However, for the gimbal assembly 135, the third rotating assembly 137a and the fourth rotating assembly 137b may be coupled between the gimbal ring 130 and the suspension hub 141, rather than to the aeronautic platform 100, to enable relative rotation about the second axis of rotation 103.

Accordingly, to support three-axis rotation, the suspension hub 141 may be coupled to the gimbal ring 130 in a similar manner to how the aeronautic platform 100 is coupled to the gimbal ring 130 in the two-axis aerial vehicle 155. In this regard, rather than being coupled between the gimbal ring 130 and the aeronautic platform 100, the third rotating assembly 137a may be coupled to the suspension hub 141 to support rotation of the suspension hub 141 and the aeronautic platform 100 about the second axis of rotation 103. As such, the inner hub 132a may be connected to the suspension hub 141 (as opposed to being connected to the aeronautic platform 100) and the axle 134a may be, for example, extended to operably couple to the suspension hub 141. Similarly, the fourth rotating assembly 137b may be coupled in the same manner, i.e., between the gimbal ring 130 and the suspension hub 141 to also support rotation of the suspension hub 141 and the aeronautic platform 100 about the second axis of rotation 103 and the axle 134b may also be, for example, extended to operably couple to the suspension hub 141. Again, the fourth rotating assembly 137b may be positioned opposite the third rotating assembly 137a such that both rotating assemblies support rotation of the suspension hub 141 and the aeronautic platform 100 about the second axis of rotation 103 as indicated by the arrows 104. Accordingly, the inner hub 132b may be connected to the suspension hub 141 rather than the aeronautic platform 100. Other than being connected to the suspension hub 141, rather than the aeronautic platform 100, and the associated modifications to the lengths of the axles 134a and 134b, the third rotating assembly 137a and the fourth rotating assembly 137b may be structured and operate in the same manner as described above for the two-axis aerial vehicle 155.

To support relative rotation about the third axis of rotation 105, the gimbal assembly 135 may further comprise a fifth rotating assembly 140 that is coupled between the third and fourth rotating assemblies 137a and 137b and the aeronautic platform 100. In this regard, the third axis of rotation 105 may be perpendicular to the first axis of rotation 101 and the second axis of rotation 103, and the fifth rotating assembly 140 may be coupled between the third and fourth rotating assemblies 137a and 137b and the aeronautic platform 100.

Unlike the rotating assemblies described above, the fifth rotating assembly 140 may be, according to some example embodiments, a singular rotating assembly that need not have a counterpart rotating assembly that rotates about the third axis of rotation 105. According to some example embodiments, the third axis of rotation 105 may be aligned with the center of gravity 125 of the aeronautic platform 100 and the intersection of the first and second axes of rotation. Further, according to some example embodiments, the aeronautic platform 100 may be wholly or partially suspended from the fifth rotating assembly 140. In this regard, according to some example embodiments, the fifth rotating assembly 140 may comprise a suspension hub 141, an axle 142, and a platform hub 143. In general, one or both of the suspension hub 141 or the platform hub 143 may enable relative rotation of the axle 142 to thereby enable relative rotation of the suspension hub 141 with respect to the aeronautic platform 100 about the third axis of rotation 105. The axle 142 may be a rotating component that may be configured to rotate with the aeronautic platform 100, rotate with the suspension hub 141, or rotate relative to both the aeronautic platform 100 and the suspension hub 141. In this regard, the axle 142 may be rotationally fixed to one of the aeronautic platform 100 or the suspension hub 141, or the axle 142 may be rotationally fixed to neither the aeronautic platform 100 nor the suspension hub 141. As an example embodiment, the following describes the axle 142 as being rotationally fixed to the platform hub 143 and the aeronautic platform 100. However, it is understood that some example embodiments may involve the axle 142 being rotationally fixed to the suspension hub 141 and rotatable within the platform hub 143, or the axle 142 may freely rotate relative to both the suspension hub 141 and the platform hub 143.

In this regard, the suspension hub 141 may be operably coupled to or affixed to the inner hubs 132a and 132b. However, according to some example embodiments, the suspension hub 141 may be positioned at a central location relative to a line from the ring hub 136a and the ring hub 136b. Further, according to some example embodiments, the suspension hub 141 may be positioned at a centroid of the external cage 150. The suspension hub 141 may be affixed to the third and fourth rotating assemblies 137a and 137b such that the suspension hub 141 does not rotate relative to the third and fourth rotating assemblies 137a and 137b. The suspension hub 141 may be a component that enables the rotation of a shaft, such as the axle 142 within the suspension hub 141. In this regard, the suspension hub 141 may comprise an opening that the axle 142 may be received into, and the axle 142 may be rotatable within the opening, while also being secured within the suspension hub 141. According to some example embodiments, the suspension hub 141 may comprise additional rotating components, such as a bearing (e.g., a ball bearing) that reduce frictional forces during rotation to enable the axle 142 to rotate more freely.

The axle 142 may be rotationally fixed to the platform hub 143. The platform hub 143 may, in turn, be rotationally fixed to the body 110 or the aeronautic platform 100. As such, the axle 142, the platform hub 143, and the aeronautic platform 100 may, according to some example embodiments, be rotatable as a unit relative to the suspension hub 141 about the third axis of rotation 105.

As such, due to the operable coupling of the suspension hub 141 between the gimbal ring 130 and the external cage 150, the gimbal ring 130 and the aeronautic platform 100 may be free to rotate about the first axis of rotation 101 relative to the external cage 150, according to some example embodiments. Further, due to the coupling of the third rotating assembly 137a and the fourth rotating assembly 137b between the gimbal ring 130 and the aeronautic platform 100, the aeronautic platform 100 may be free to rotate about the second axis of rotation 103 relative to the external cage 150, according to some example embodiments.

Due to the coupling of the first rotating assembly 115a and the second rotating assembly 115b between the gimbal ring 130 and the external cage 150, and the third rotating assembly 137a and the fourth rotating assembly 137b being coupled between the gimbal ring 130 and the aeronautic platform 100, and the coupling of the fifth rotating assembly 140 as described above, the aeronautic platform 100 may be free to rotate about the first axis of rotation 101, second axis of rotation 103, and the third axis of rotation 105. According to some example embodiments, the first axis of rotation 101 may be positioned such that the first axis of rotation 101 is within a first plane that includes the center of gravity 125 and bisects the weight of the aeronautic platform 100. The first axis of rotation 101 is also positioned on a second plane that is normal to the weight force vector 109 directed from the center of gravity 125, where a portion of the aeronautic platform 100 on a side of the second plane that is intended to be directed towards the ground is heavier than a portion of the aeronautic platform 100 that is intended to be directed towards the sky. In the example embodiments described with respect to FIG. 1E, the entire weight of the aeronautic platform 100 may be on one side of this second plane, when the aeronautic platform 100 is not subjected to a moment of force or torque that causes the aeronautic platform 100 to pivot relative to the weight force vector 109. Additionally, the second axis of rotation 103 may be positioned such that the second axis of rotation 103 is within a third plane that includes the center of gravity 125, is perpendicular to the first plane, and also bisects the weight of the aeronautic platform 100. The second axis of rotation 103 may also positioned on the second plane that is normal to the weight force vector 109 directed from the center of gravity 125, where a portion of the aeronautic platform 100 on a side of the of the second plane that is intended to be directed towards the ground is heavier than a portion of the aeronautic platform 100 that is intended to be directed towards the sky. Also, the third axis of rotation 105 may be positioned at the intersection of the first plane and the third plane, which defines a line through the center of gravity 125. As such, the free rotation of the aeronautic platform 100 about the first axis of rotation 101, the second axis of rotation 103, and the third axis of rotation 105 may result in the top side 107 of the aeronautic platform 100 being directed away from the ground and towards the sky. Positioning of the first axis of rotation 101, the second axis of rotation 103, and the third axis of rotation 105 in this manner may cause the aeronautic platform 100 to be generally maintained in a desired orientation. As a result, a GPS receiver on the top side 107 may maintain orientation towards the sky to permit satellite signals for GPS positioning to be received. Further, the aeronautic platform 100 may rotate, due to gravity, into an orientation that facilitates returning to flight when the aerial vehicle 157 is, for example, at rest on the ground, regardless of the position of the external cage 150. In this regard, the aeronautic platform 100 may rotate such that the thrust generated by the propellers 112 is directed downward to facilitate flight.

In view of the foregoing, the combination of the external cage 150 and the gimbal assembly 131, the gimbal assembly 133, or the gimbal assembly 135 constructs a barrier assembly for the aeronautic platform 100. Such a barrier assembly, according to some example embodiments, may provide the aeronautic platform 100 with collision protection and orientation benefits that overcome a variety of technical challenges. In this regard, collision impact forces may be reduced by the presence of the rotatable external cage. Additionally, the external cage 150 and gimbal assembly 131, 133, 135 may operate to cause the aeronautic platform 100 to maintain a desired orientation relative to the ground, even when flight propulsion, which may be otherwise needed to maintain such desired orientation, is lost. With the external cage 150 and the gimbal assembly 131, 133, 135 maintaining a desired orientation of the aeronautic platform 100, even after a fall from flight, the probability of a return to flight (without externally sourced physical movement) is significantly increased.

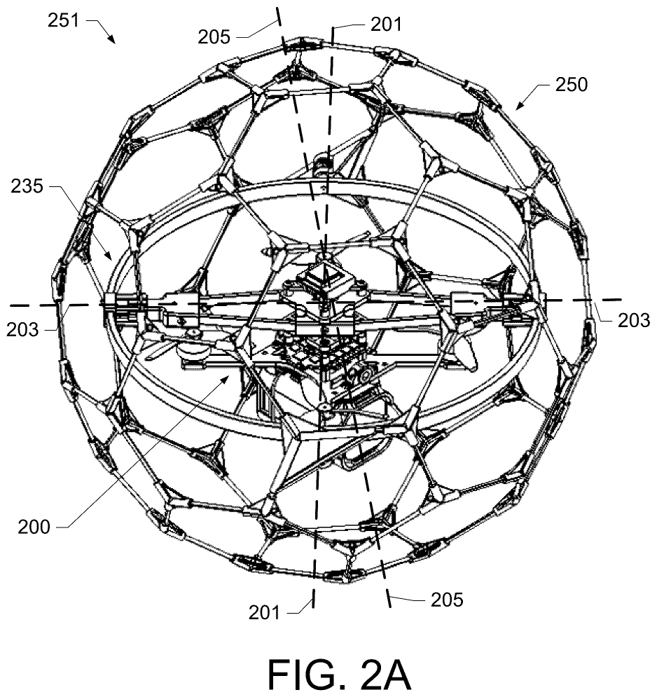

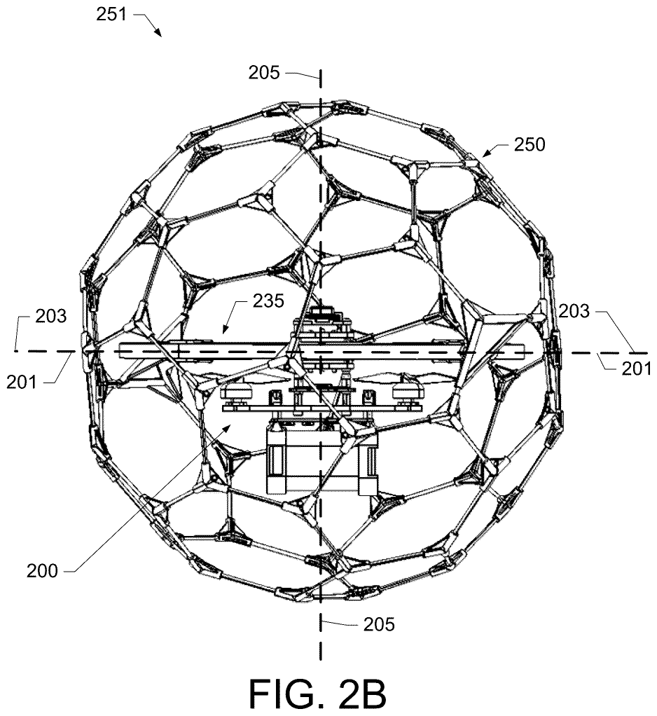

Having described some example embodiments as shown in FIGS. 1A to 1E, further example embodiments will now be described with reference to another vehicle in the form of a vehicle 251, which may be an aerial vehicle, as shown in FIGS. 2A and 2B, and components or variations thereof. In this regard, the vehicle 251 may comprise an external cage 250, a propulsion platform 200, and a gimbal assembly 235. As mentioned above a barrier assembly of the vehicle 251 may comprise the external cage 250 and the gimbal assembly 235. While a gimbal assembly, according to some example embodiments, may be embodied as a one-axis, two-axis, or three-axis gimbal assembly, the gimbal assembly 235 is shown as a three-axis gimbal assembly. In this regard, based on the enabling description provided herein, one of ordinary skill in the art would be enabled to modify the three-axis gimbal assembly 235 to embody a two-axis or one-axis gimbal assembly embodiment. The gimbal assembly 235 may be a passive device that enables free, non-driven, rotation of the propulsion platform 200 relative to the external cage 250 about a first axis of rotation 201, a second axis of rotation 203, and a third axis of rotation 205. The propulsion platform 200 may be operably coupled to the external cage 250 via the gimbal assembly 235.

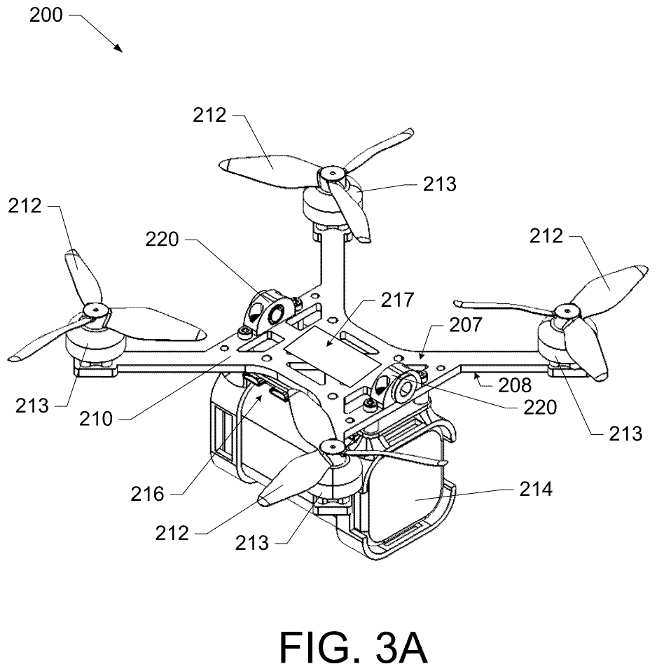

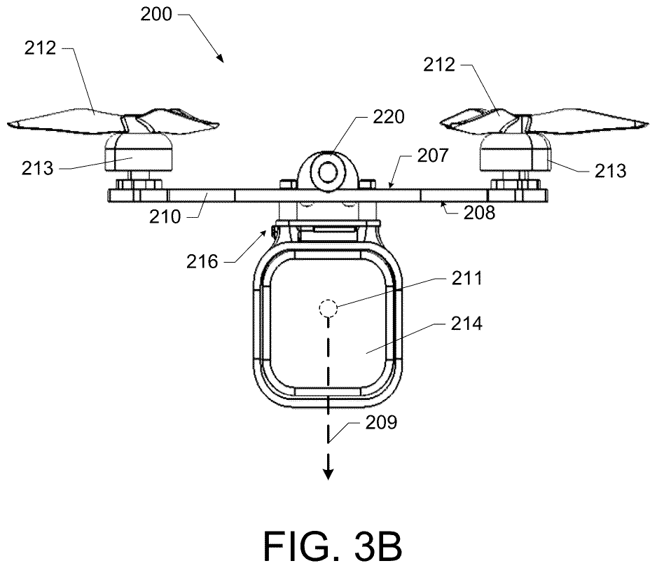

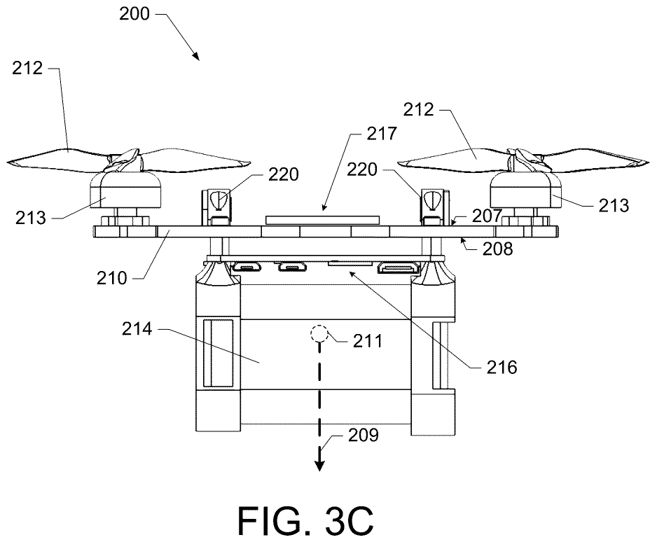

Referring now to FIG. 3A to 3C, an example embodiment of the propulsion platform 200 is shown. The propulsion platform 200 may be embodied, as shown here, as an aerial platform similar to aeronautic platform 100. However, the propulsion platform 200 may also be implemented in other contexts such as, for example, as an aquatic platform for navigation underwater. The propulsion platform 200 may be a portion of the vehicle 251 that provides propulsion to the vehicle 251 for maneuvering, for example, in flight. In this regard, the propulsion platform 200 may be configured to perform human-controlled or autonomous navigation and maneuvering. As such, the propulsion platform 200 may include communications components to support wireless communications for receipt of control signals and transmission of the sensor data (e.g., image data captured by a camera or optical sensor).

According to some example embodiments, the propulsion platform 200 may comprise a body 210, a power circuitry 216, control circuitry 217, a battery 214, a plurality of motors 213, and a plurality of propellers 212. The body 210 may be, for example, a frame of the propulsion platform 200, and the body 210 may be configured to support some or all of the components of the propulsion platform 200. The body 210 may comprise, for example, a central base portion from which a plurality of arms may extend to support respective propulsion assemblies. According to some example embodiments, a motor 213 and a propeller 212 operably coupled to a driven shaft of the motor 213 may be disposed on each arm of the body 210. The motors 213 may be configured for individual control to thereby control a rotation speed of a respective propeller 212. Such individual control of the motors 213 may enable control of three-dimensional movement of the propulsion platform 200. According to some example embodiments, the propulsion platform 200 may comprise a quad-copter and may therefore include four motors 213 and four propellers 212. The propellers 212 may be oriented to provide thrust directed in a common direction, although some propellers 212 may be rotated in opposite directions for maneuverability.

The battery 214 may provide electrical power to the propulsion platform 200 to power the power circuitry 216, the control circuitry 217, and the plurality of motors 213. In this regard, according to some example embodiments, the battery 214 may be a rechargeable battery and the battery 214 may be sized to provide sustained electrical power to perform a task of a given duration. As mentioned above, the battery 214 may be a relatively heavy component of the propulsion platform 200. As such, according to some example embodiments, the battery 214 may be affixed to, for example, a bottom side 208 of the body 210. As a result, the center of gravity 211 of the propulsion platform 200 may be positioned, for example, below a plane of the body 210. Additionally, other components may be placed with a position of the center of gravity 211 being considered. According to some example embodiments, the weight distribution may be such that a weight force vector 209 from the center of gravity 211 would extend through a centroid of a volume of the propulsion platform 200. In other words, the weight distribution of the propulsion platform 200 may be evenly distributed in two dimensions to define a center of gravity with respect to those two dimensions. If the propulsion platform 200 is suspended at a position aligned with the center of gravity with respect to those two dimensions, the propulsion platform 200 will rotate, by the force of gravity into a position where the center of gravity in the third dimension closest to the ground. Accordingly, the propulsion platform 200 may have a weight distribution for a suspension point such that gravity positions a top side 207 (and, for example, a GPS receiver on the top side 207) facing upwards towards the sky. Further, such positioning causes the thrust direction of the propellers 212 to be directed downward to enable takeoff and flight.

The power circuitry 216 may be disposed, for example, adjacent to the battery 214. In this regard, the battery 214 may be affixed such that a gap or platform is disposed between the body 210 and the battery 214. As such, the power circuitry 216 may be disposed on the platform or the bottom side of the body 210. The power circuitry 216 may control operation and charging of the battery 214. Since the power circuitry 216 may be positioned without regard to, for example, signal reception, the power circuitry 216 may be positioned anywhere on the propulsion platform 200.

Additionally, the control circuitry 217 may be the same or similar to the control circuitry 116 with the GPS component 118 described above. In this regard, the control circuitry 217 may include a processor and a memory and a position sensor, which may comprise a GPS sensor. As described herein, the control circuitry 217 may be configured to control the navigation and maneuvering of the propulsion platform 200 based on, for example, data from the position sensor, via remote human control or autonomous control. According to some example embodiments, the control circuitry 217 may include radio communications components that are configured to transmit and receive communications associated with tasks being executed by the vehicle 251.

According to some example embodiments, the propulsion platform 200 may be configured for implementation with a single-axis or two-axis gimbal assembly. In this regard, the propulsion platform 200 may include hubs 220 that are affixed to the top side 207 of the body 210. These example hubs 220 may be configured to receive a rotatable axle that is operably coupled to the external cage 250 (similar to the example embodiments associated with FIG. 1C) or operably coupled to a gimbal ring (similar to the example embodiments associated with FIG. 1D). In this regard, according to some example embodiments, the hubs 220 may be disposed on opposite sides of the body 210 and the hubs 220 may be positioned such that a line between the two hubs 220, which also defines an axis of rotation, and the center of gravity 211 of the propulsion platform 200 define a plane that bisects the weight of the propulsion platform 200. Further, a plane defined as being normal to the weight force vector 209 of the propulsion platform 200 that includes the axis of rotation associated with the hubs 220 may have more weight on an intended bottom side of the plane than on the top side of the plane. Accordingly, due to the positioning of the axis of rotation in this manner, the propulsion platform 200 may generally maintain an orientation with the top side 207 facing the sky for GPS signal reception. Additionally, the maintained orientation is also beneficial for returning to flight from the ground.

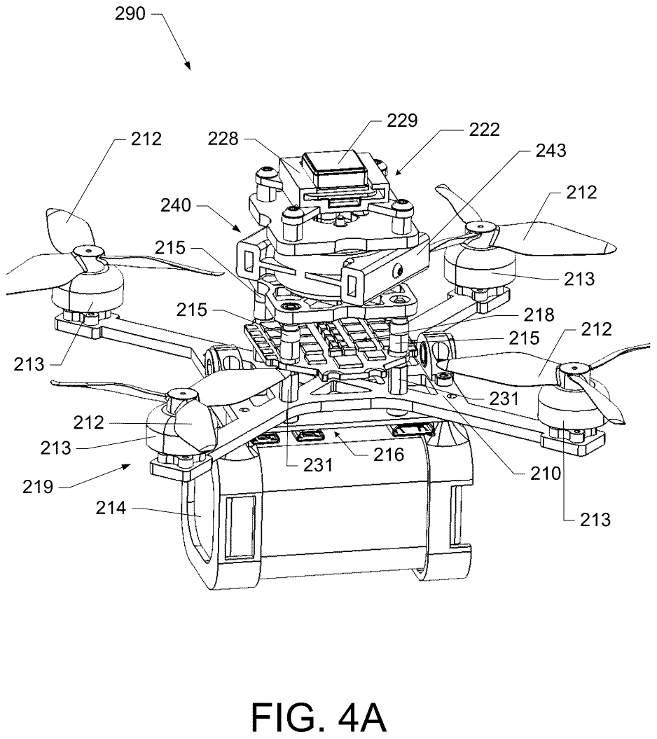

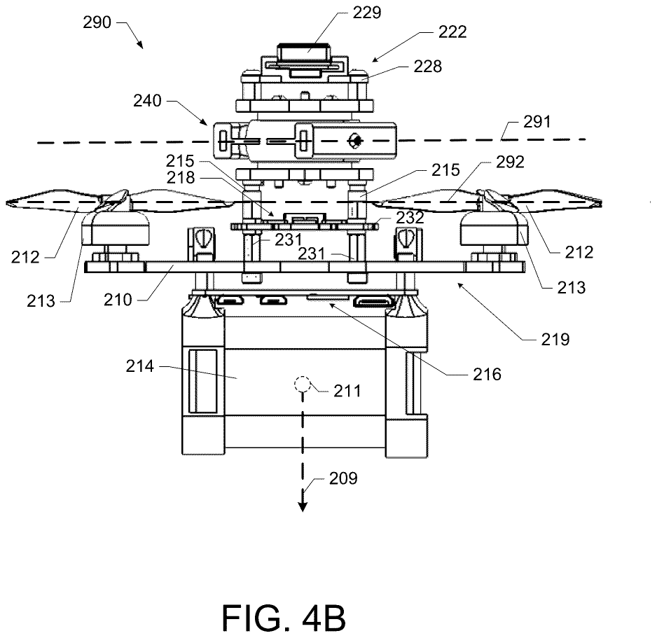

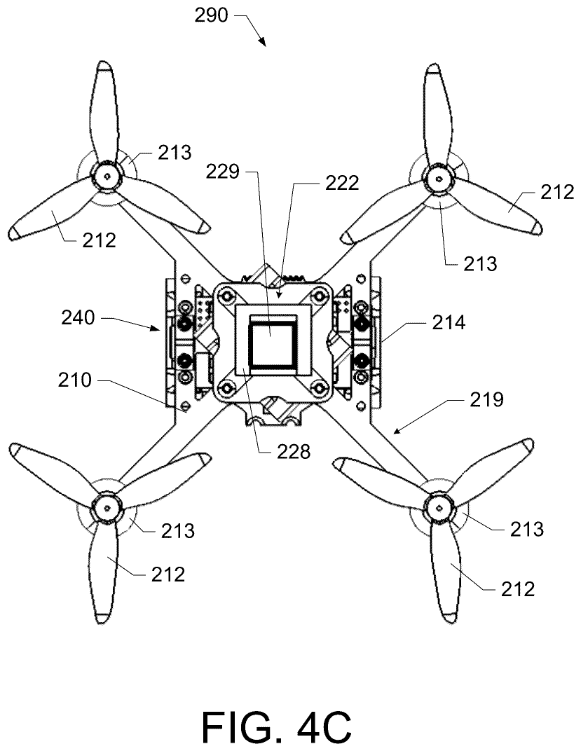

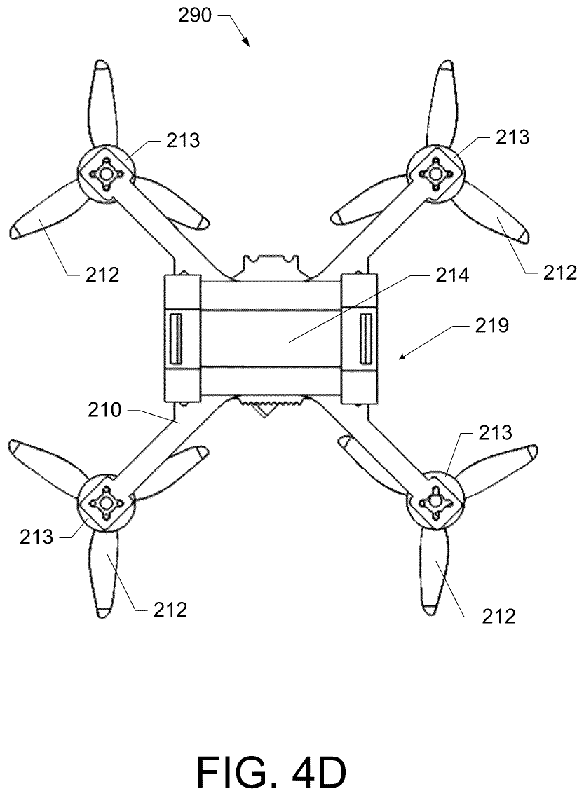

Now referring to FIGS. 4A to 4D, another example embodiment of a propulsion platform 290 is shown. In this regard, the propulsion platform 290 is similar to the propulsion platform 200, however, modified to include an upper and a lower portion. In this regard, the propulsion platform 290 may comprise a lower portion 219 and an upper portion 222. The lower portion 219 may be similar to the propulsion platform 200. The upper portion 222 may be configured to place position circuitry 229 in a less obstructed position above a suspension hub 240, which is similar to the fifth rotating assembly 140 with the suspension hub 141 described above. Although the suspension hub 240 is shown in FIGS. 4A to 4D, the suspension hub 240 may be a component of the gimbal assembly 235. Moreover, the propulsion platform 290 may comprise the battery 214, the power circuitry 216, the motors 213, and the propellers 212. These components may be structured and operate in the same or similar manner as described above with respect to the example embodiments described with respect to FIGS. 3A to 3C.

However, according to some example embodiments, the lower portion 219 of the propulsion platform 290 may comprise standoffs 231 that support a board 232, which may be a printed circuit board (PCB). Control circuitry 218 may be disposed on the board 232. In this regard, a processor and memory may, according to some example embodiments, be disposed on the board 232. Positioning of the power distribution and control circuitry 218 on the board 232 may permit the board 232 to be separately assembled and may permit air flow around the control circuitry 218 for cooling.

The upper portion 222 may comprise a board 228 and position circuitry 229. The board 228 may also be a PCB. In this regard, the position circuitry 229 may comprise, for example, a GPS receiver or GPS component configured to determine a position of the GPS receiver/component. The propulsion platform 290 may be configured to couple to, for example, a three-axis gimbal assembly. According to some example embodiments, the propulsion platform 290 may be configured to couple with at least a single-axis gimbal assembly that enables rotation of the propulsion platform 290 about an axis of rotation that is defined as being aligned with a direction of the weight force vector of the propulsion platform 290 with respect to the center of gravity 211. In this regard, although the suspension hub 240 is shown, the suspension hub 240 may be component of a gimbal assembly. However, because the suspension hub 240 may be disposed above the position of the control circuitry 217, inclusion on a GPS receiver on the board 232 may inhibit the GPS receiver's ability to receive satellite signals. As such, according to some example embodiments, the board 228 positioned above the suspension hub 240 may include position circuitry 229, which may include a GPS receiver or other components that would benefit from such positioning. As further, described below, the suspension rotating assembly 240 may comprise a central channel that permits conductors (e.g., wires and the like) to extend from the control circuitry 218 to the position circuitry 229 without impeding the rotation of the suspension hub 240.

Additionally, the suspension hub 240 may include a rotating member 243. The rotating member 243 may be configured to operably couple to beams that are operably coupled to a gimbal ring 230. To provide clearance space and avoid physical interference between the beams or other components of the gimbal assembly, the propulsion platform 290 may include additional standoffs 215 that, for example, raise the rotating member 243 to operate within the plane 291. In this manner, the rotation of the rotating member 243 and components affixed to the rotating member 243, within the plane 291, avoid contact with the propellers 212, which operate within a lower plane 292.

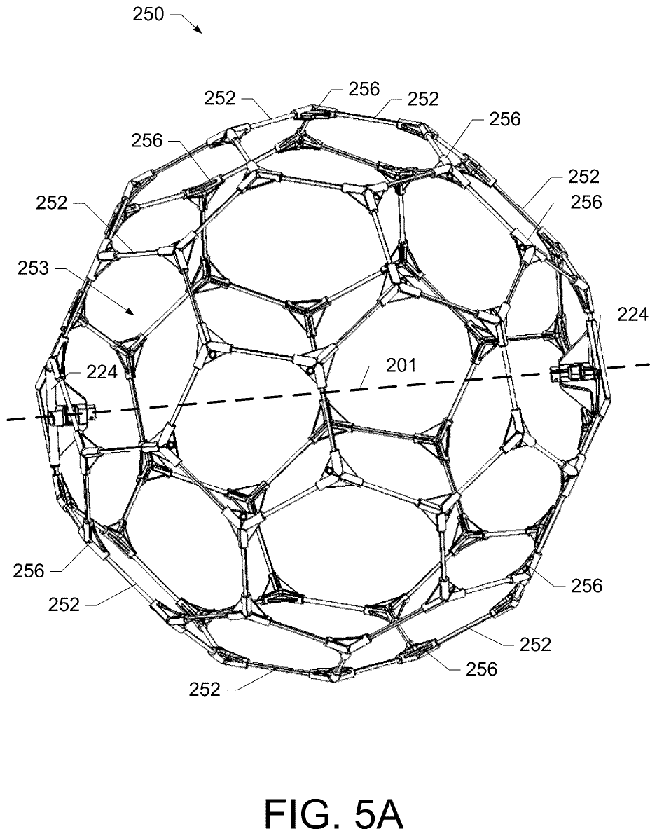

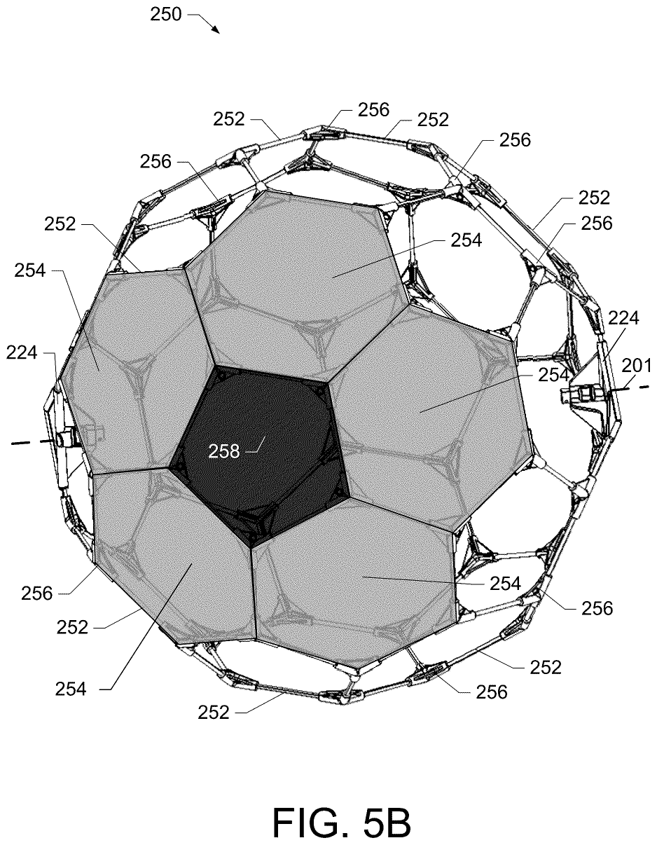

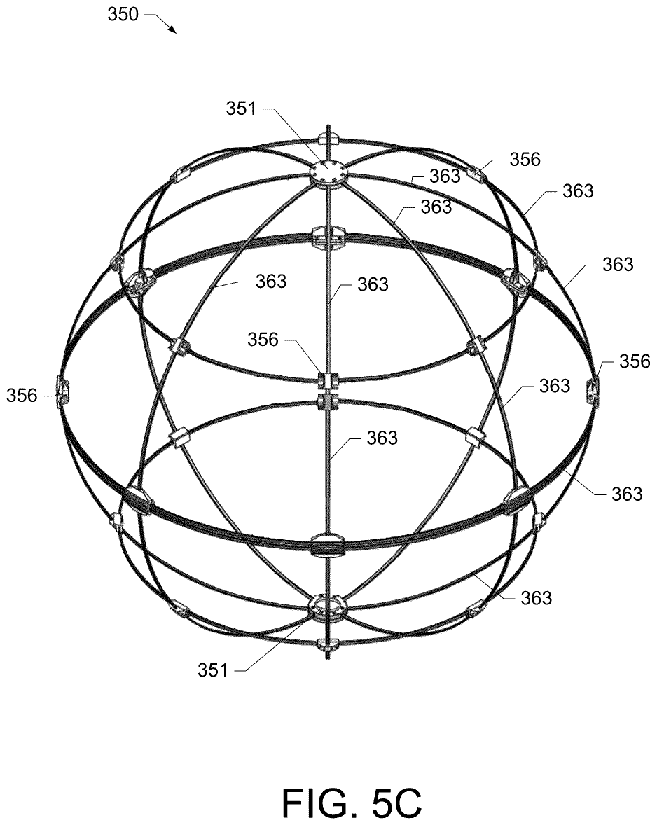

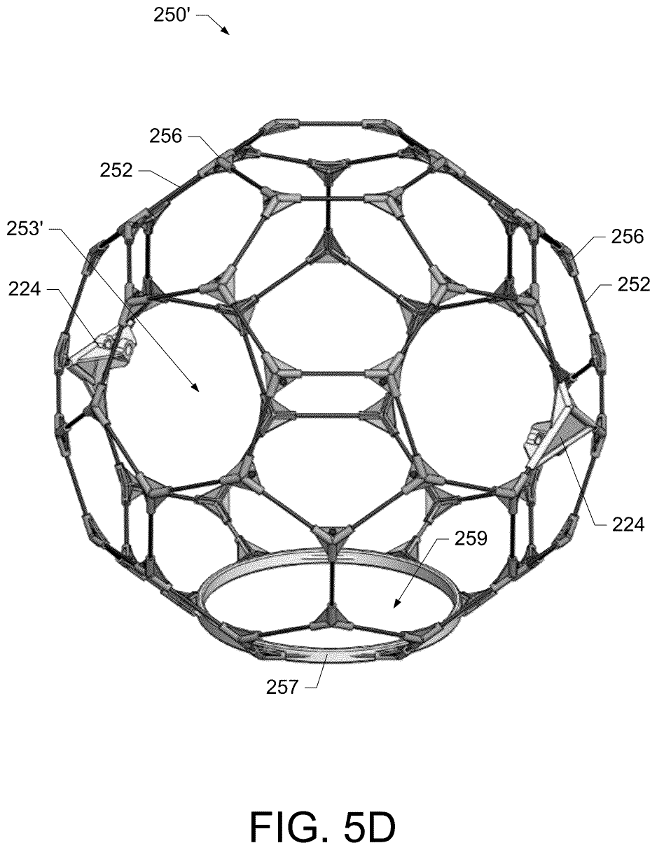

Now referring to FIG. 5A, the external cage 250 is shown in isolation from the propulsion platform 290, and many of the components of the gimbal assembly 235. According to some example embodiments, the external cage 250 may be generally spherical in shape. However, a generally spherical shape is merely an example shape that may be implemented in accordance with some example embodiments. Other shapes may include elongated spheres, cubes, prisms, cones, cylinders, other three-dimensional shapes formed of various shaped polygons, and the like. The specific example embodiment of the external cage 250 may comprise an interconnection of two-dimensional, polygon shapes sized to form a three-dimensional structure with an internal volume. The polygon shapes may define openings into the internal volume 253 of the external cage 250. According to some example embodiments, a largest dimension of such openings may be smaller than a smallest dimension of the propulsion platform 290. According to some example embodiments, the polygon shapes that make up, for example, the external cage 250 and may share vertices to form such an enclosure that defines the internal volume 253, within which the propulsion platform 290 and the gimbal assembly 235 may be disposed.

The external cage 250 may be constructed, according to some example embodiments, via the interconnection of rods 252 and vertex connectors 256. The rods 252 may, for example, be elongate members that extend between two ends. The vertex connectors 256 may be interconnection components where the ends of a plurality of rods 252 meet and are secured, for example, within a respective receiving cavity of the vertex connector 256. In some example embodiments, the rods may be flexible to permit bending to, for example, assist in absorbing an impact on the external cage 250. Accordingly, the vertex connectors 256 may be rigid to, for example, maintain the overall structure of the external cage 250 with the flexible rods 252. However, in other example embodiments, the rods 252 may be rigid. For example, the rods 252 may be constructed of or comprise carbon fiber, fiber glass reinforced plastic (FRP), metal, or another material that has similar or large bending stiffness. With the rods 252 being rigid, according to some example embodiments, the vertex connectors 256 may be flexible (e.g., about shore 98). In this regard, the material and structure of the vertex connectors 256 may facilitate flexing movement of the rods 252. According to some example embodiments, the vertex connectors 256 may be constructed of or comprise thermoplastic polyurethane (TPU). For example, the receiving cavities of the vertex connectors 256 may permit the rods 252 to pivot inwardly (i.e., toward the internal volume 253) about an intersection point of a vertex connector 256. Accordingly, the vertex connectors 256 may provide flexibility to the external cage 250 to absorb an impact, while the rods 252 provide structural rigidity to maintain the shape of the external cage 250. According to some example embodiments, the rods 252 and the vertex connectors 256 may be constructed via three-dimensional printing using a 3D printer and associated methods. Further, the construction of the external cage 250 may have structural characteristics to support the weight of the propulsion platform 290 off the ground when the external cage 250 is on the ground.

The rods 252 and vertex connectors 256 are shown in FIG. 5A in an assembled configuration. However, according to some example embodiments, some or all of the rods 252 may be removable from the vertex connectors 256 to enable disassembly of some or all of the external cage 250, and subsequent reassembly of the external cage 250 by reconnecting the rods 252 to the vertex connectors 256. Such disassembly may enable storage of the external cage 250 in a smaller volume, maintenance of external cage 250 components, or replacement of external cage 250 components.

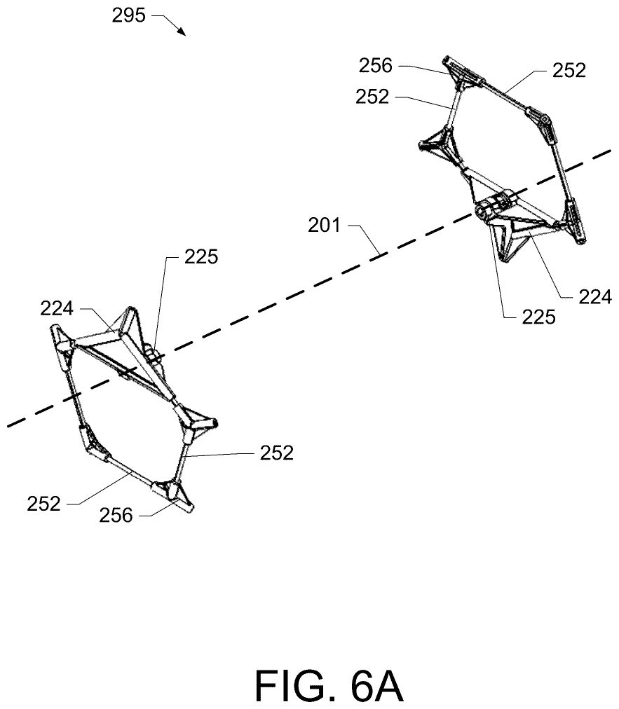

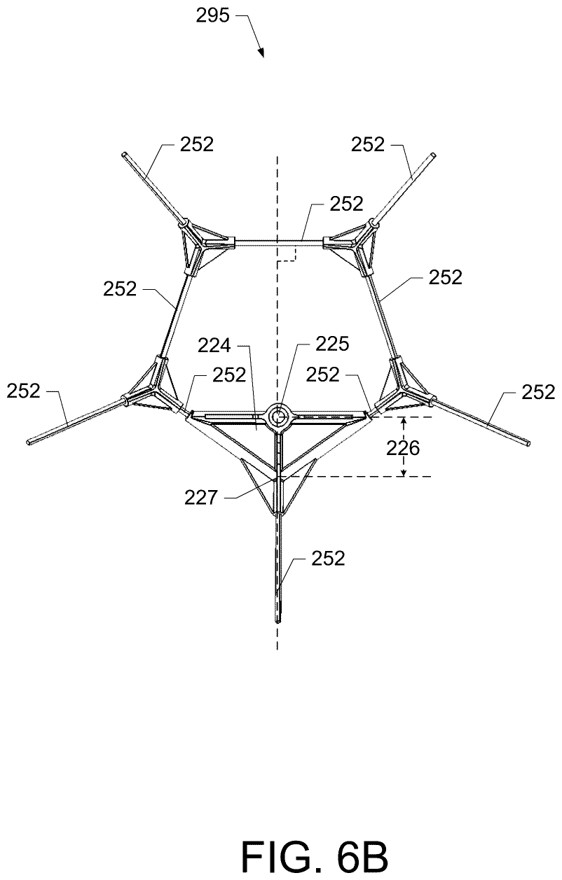

The gimbal assembly 235 may comprise a number of rotating assemblies, such as the first through fifth rotating assemblies described above but embodied as described with respect to the gimbal assembly 235. Because the gimbal assembly 235, according to some example embodiments, may be coupled to the external cage 250, the construction of the external cage 250 may include connection points for connecting the gimbal assembly 235 to the external cage 250. According to some example embodiments, the connection members to connect the gimbal assembly 235 to the external cage 250 may function only in support of the operation of the gimbal assembly 235 and may be connected to the external cage 250 at a specific location. In such an example embodiment, a cage hub may be connected to a rod 252 or a vertex connector 256 as a separate component. Alternatively, according to some example embodiments, a hybrid cage hub 224 may be used that functions to both connect rods 252 of the external cage 250 at a respective vertex similar to a vertex connector 256 and also comprise a gimbal assembly connection interface. The cage hub 224 of FIG. 5A (also shown in FIGS. 5B, 6A, and 6B) may include a receiving cavity for receiving an axle of the gimbal assembly 235 that, for example, may be operably coupled to the propulsion platform 290 or a gimbal ring of the gimbal assembly 235. However, as described herein, the cage hubs 224 may be positioned on the external cage 250 at locations that are a maximum distance apart. In example embodiments where the external cage 250 is a substantially spherical shape, the maximum distance apart may be a diameter length. Accordingly, the positioning of the cage hubs 224 may be associated with respective rotating assemblies of the gimbal assembly 235 and therefore the placement of the cage hubs 224 may define an axis of rotation 201.

FIGS. 5B and 5C will now be described which illustrate some example architectures of an external cage according to some example embodiments. Because a propulsion platform 290 is to be disposed within the external cage, one consideration is the effect that the cage may have on the thrust generated by propellers 212 of the propulsion platform 290. In this regard, the selection of an architecture of the external cage 250 may balance structural integrity, with medium flow (e.g., air flow) into and out of the internal volume 253 of the external cage 250. As such, according to some example embodiments, high structural integrity with a desired degree of elasticity for collision absorption may be desirable. Further, although generally inversely proportional, an external cage with low air flow resistance for maneuverability and high surface area for barrier protection may also be desirable. In this regard, the openings formed by the polygon shapes generated by the rods 252 and the vertex connectors 256 may be sufficiently large to reduce air flow resistance and the effect on thrust, but also sufficiently small to block obstacles from passing into the internal volume 253 and impacting the propulsion platform 290. Further, according to some example embodiments, it may also be desirable to have smaller openings in the external cage 250 to facilitate implementation of ground rolling functionality, where the external cage 250 is in contact with the ground and rolling while the vehicle 250 is in motion.

In view of various considerations, the example external cage 250 may be constructed of a pattern of polygon shapes that include pentagons 258 and hexagons 254. More specifically, the pentagons 258 may be equilateral pentagons and the hexagons 254 may be equilateral hexagons, such that all sides of the pentagons 258 are the same length as all sides of the hexagons 254. As shown in FIG. 5B, for understanding, one pentagon 258 has been highlighted with a dark color and the surrounding hexagons 254 have been highlighted in a lighter color. As such, this general pattern of a pentagon 258 surrounded by hexagons 254 on each of its sides can be repeated to construct the generally spherical shape of the external cage 250. Such an architecture, according to some example embodiments, has a relatively high structural integrity for addressing impact events and also a relatively small surface to reduce the interference with propeller thrust. The structure of the external cage 250, as shown in FIG. 5B may have the same or similar structure as a Buckyball or a carbon 60 molecule, and may therefore exhibit some of the same structural benefits and advantages. In this regard, for example, the size of the external cage 250 may be scalable to smaller or larger sizes with this same architecture and generally maintain the same or similar structural integrity for vehicle applications as described herein.

As an alternative example embodiment, the external cage 350 of FIG. 5C is provided. For the external cage 350, the rods of different lengths and configurations may be used to construct the architecture. Further, various configurations of vertex connectors 256 are also used. In this regard, the architecture of the external cage 350 may be formed from a plurality of circular components that form three-dimensional, curved shapes (as opposed to the planar shapes of the external cage 250). In this regard, four longitudinal circular structures may extend between a top pole vertex connector 351 and a bottom pole vertex connector 351, which are positioned at the intersection of the four longitudinal circle structures. Such longitudinal circular structures may be equally spaced and intersect only at the vertex connectors 351. Rods 363 may be flexible to bend into a desired curved shape or the rods 363 may be rigid and also curved. According to some example embodiments, the external cage 350 may also comprise a plurality of latitudinal circular structures. In the example embodiment of the external cage 350, three latitudinal circular structures are used. Each latitudinal circular structure may be constructed from rods 363 connected to vertex connectors 356, which are positioned at intersections between a latitudinal circular structure and a longitudinal circular structure. As a result, a substantially spherical shaped external cage 350 may be formed that may be used in association with, for example, gimbal assemblies and propulsion platforms described herein.

Additionally, according to some example embodiments, the external cage 350 may be formed as two hemisphere components that can be assembled in the spherical shape and disassembled into the two hemisphere components and, for example, nested into each other to reduce the volume for storage. In this regard, according to some example embodiments, two circular rods 363 may be centrally positioned at, for example, an equator position of the external cage 350 with the vertex connectors 351 defining the poles. The two rods 363 may be positioned adjacent to each other and specialized vertex connectors 356 may be used that releasably couple the two adjacent rods 363 together.

FIG. 5D illustrates a modification to the external cage 250 embodied as external cage 250′. Rather than a continued series of the repeating patterns of pentagons and hexagons described above, the external cage 250′ comprises a large access opening 259 within its architecture. Similar to the external cage 250, the external cage 250′ may be constructed by rods 252 and vertex connectors 256. Additionally, the cage hubs 224 may be used. A ring member 257 may be included in the construction of the external cage 250′ and interconnected with specialized rods 252 and vertex connectors 256 to support the ring member 257. The presence of the ring member 257 within the architecture of the external cage 250′ may create a larger passageway into the internal volume 253′ of the external cage 250′ via the access opening 259. Such an opening and associated passageway may operate to support additional functionality of a vehicle that implements the external cage 250′. For example, the access opening 259 may support capture and release of cargo. Additionally or alternatively, the access opening 259 may allow the associated vehicle to descend onto a charging interface, for example in the form of a post that can extend into the internal volume 253′ through the access opening 259.

As described herein, the external cage may be free to rotate in relation to one or more axis of rotation. However, according to some example embodiments, the external cage may rotate freely, and therefore may have an unpredictable positioning relative to the propulsion platform due to the operation of the gimbal assembly. However, as described herein, the positioning of the axes of rotation may be selected, based on the weight distribution of the propulsion platform to ensure that the propulsion platform is oriented as desired relative to the ground. As such, a bottom of the propulsion platform may be maintained on a ground side of the propulsion platform due to the propulsion platform's ability to freely rotate relative to the external cage. According to some example embodiments, an engineered weight distribution of the external cage may also be used to orient the external cage relative to the ground. In this regard, rather than having a centrally located center of gravity (i.e., a symmetric weight distribution), components of the external cage may be weighted more heavily or additional weights may be added to use gravity to orient the external cage in a desired position relative to the ground.

As such, according to some example embodiments, the external cage 250′ may have a weight distribution that places the center of gravity out of a central position and, for example, closer to the ring member 257. Such a weight distribution may be accomplished by using, for example, heavier rods or heavier vertex connectors near the ring member 257. Additionally or alternatively, weights may be included near the ring member 257 or the ring member 257 itself may be weighted to place the center of gravity of the external cage 250′ near the ring member 257. As a result of such a weight distribution, the orientation of the external cage 250 may be predicable since the external cage 250′ may rotate to orient the side of the external cage 250 closest to the center of gravity towards the ground. As such, use of the access opening 259 may be predicable as the access opening 259 may generally be located below the propulsion platform 290, when weighted accordingly, to support access into the internal volume 253 from below. One of ordinary skill in the art would appreciate that the center of gravity could be moved elsewhere via changes to the weight distribution to have the access opening 259 generally oriented in other locations such as above the propulsion platform 290 or elsewhere to support, for example, unobstructed image capture from a camera on-board the propulsion platform 290.

Having described aspects of the propulsion platform 290 and the external cage 250, example embodiments of the gimbal assemblies and components of gimbal assemblies will now be described with respect to FIGS. 6A to 9E. More specifically, example embodiments of a gimbal assembly 295 that is configured to support a single-axis of rotation is shown in FIGS. 6A and 6B. Following from the structure of the external cage 250, FIG. 6A illustrates two pentagon structures, in isolation, that may be disposed on opposite sides of the external cage 250. In this regard, the respective pentagon structures may be constructed using four vertex connectors 256, five rods 252, and a cage hub 224. As mentioned above, the cage hub 224 may be a hybrid component that operates to both couple rods 252 at a vertex and includes an axle interface 225 for securing an axle of the gimbal assembly to the cage hub 224, while also enabling the axle to rotate about an axis of rotation 201. According to some example embodiments, the cage hubs 224 may include friction reduction features and components such as providing the axle interface 225 with a low-friction surface (via coating or the like) or by including a bushing, bearing, such as a ball bearing. The cage hubs 224 may be positioned across the external cage 250 from each other such that a distance between the cage hubs 224 is a maximum distance between two points on the external cage 250.

Additionally, with reference to FIG. 6B, it can be seen that the axle interface 225 may disposed on the cage hub 224 at a position that is not aligned with a vertex of the pentagon structure. In this regard, due to the relational positions of the vertices of the external cage 250, according to some example embodiments, no two vertices may be positioned such that a line through the vertices also passes through a centroid of the external cage 250. As such, the cage hub 224 may extend into the pentagon structure from a vertex 227 by a distance 226 to position the axle interface at a location that causes the axis of rotation 201 to pass through the centroid of the external cage 250. In this regard, according to some example embodiments, the axle interface 225 may be positioned a distance 226 away from the vertex 227 on a line that bisects an opposite side of the pentagon structure at a right angle.

Accordingly, with the cage hubs 224 positioned in this manner within the external cage 250, the propulsion platform 290 may be operably coupled to the cage hubs 224 to enable single-axis relative rotation of the propulsion platform 290 about the axis of rotation 201. The propulsion platform 290 may be operably coupled to the cage hubs 224 via respective axles that are operably coupled to the propulsion platform 290. According to some example embodiments, such axles may be operably coupled to the hubs 220 on the body 210 of the propulsion platform 290 to support single-axis relative rotation.

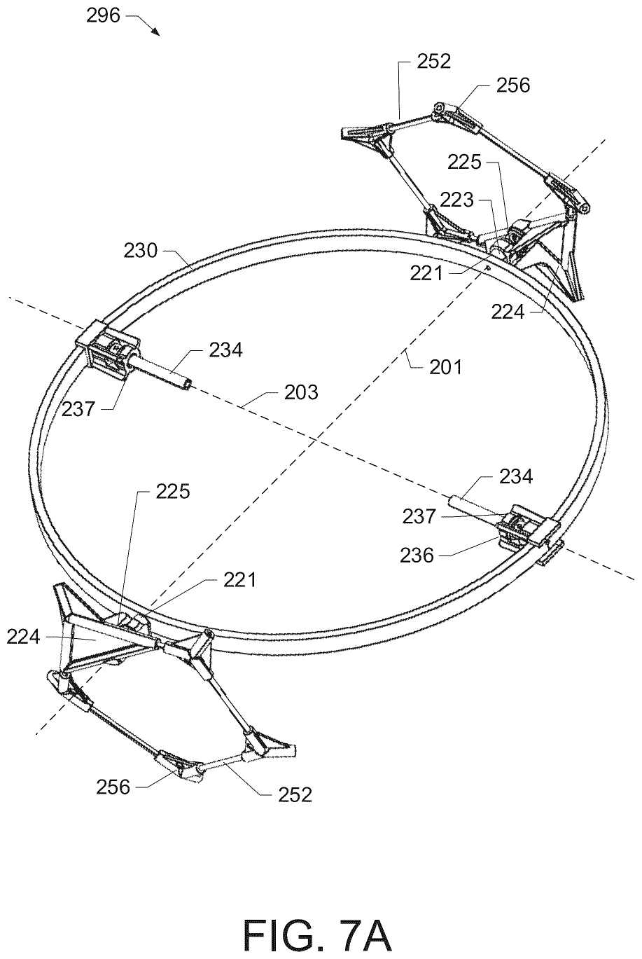

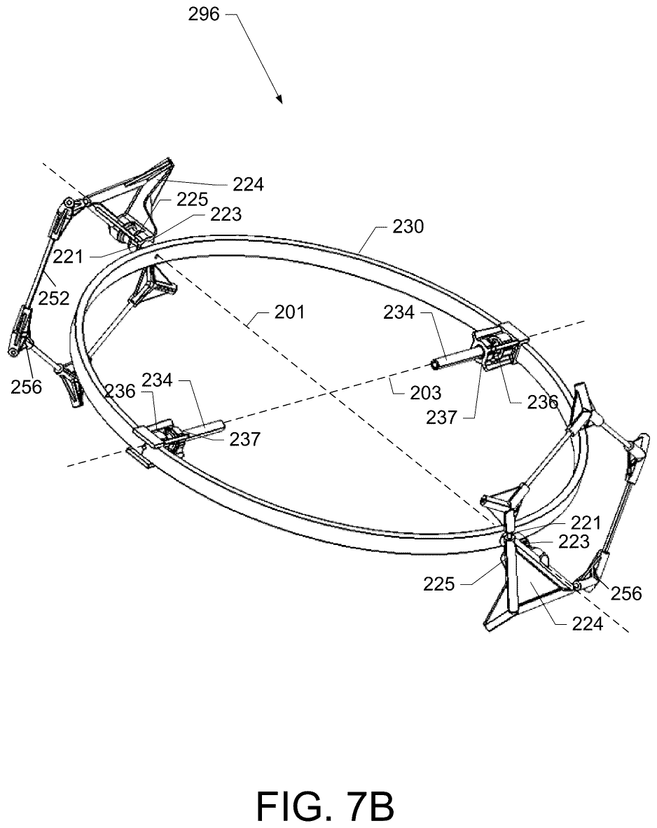

Now referring to FIGS. 7A and 7B, an example embodiment of a two-axis gimbal assembly 296 is shown. In this regard, the gimbal assembly 296 may comprise the cage hubs 224 coupled to the respective pentagon structures described with respect to FIGS. 6A and 6B. Further, the gimbal assembly 296 may comprise axles 223, inner hubs 221, a gimbal ring 230, ring hubs 236, and axles 234. In this regard, a cage hub 224, an axle 223, and an inner hub 221 may be components of a rotating assembly that functions to enable the gimbal ring 230 to rotate about the first axis of rotation 201. Rather than being operably coupled to the propulsion platform 290 as described in the single-axis gimbal assembly 295, the axles 223 may be operably coupled to respective inner hubs 221 that are affixed to the gimbal ring 230 to support a first axis of rotation 201 for a gimbal assembly 296.

The second axis of rotation 203 may be positioned based on the positioning of the ring hubs 236. According to some example embodiments, the ring hubs 236 may be positioned across from each other on the gimbal ring 230 such that a line between the ring hubs 236 (which is also on the second axis of rotation 203) is a diameter and passes through a center of, for example, the circle formed by the gimbal ring 230. Additionally, the ring hubs 236 may also be positioned such that the line between the ring hubs intersects a line between the axle interfaces 225 of the cage hubs 224. As such, the line between the ring hubs 236 may be perpendicular to the line between the cage hubs 224. Similar to the cage hubs 224, the ring hubs 236 may comprise an axle interface 237, and the ring hubs 236 may be affixed to the gimbal ring 230 via, for example, a clamp or other securing feature. The axle interfaces 237 may engage with respective axles 234 that extend from the axle interfaces 237 along the second axis of rotation 203.

Accordingly, with the cage hubs 224 positioned in this manner within the external cage 250 and the ring hubs 236 positioned in this manner on the gimbal ring 230, the propulsion platform 290 may be operably coupled to the axles 234 to enable two-axis rotation of the propulsion platform 290 relative to the external cage 250. In this regard, the gimbal assembly 296 may support relative rotation about the first axis of rotation 201 and about the second axis of rotation 203. The propulsion platform 290 may be operably coupled to the axles 234, according to some example embodiments, via the hubs 220 on the body 210 of the propulsion platform 290 to support two-axis relative rotation.

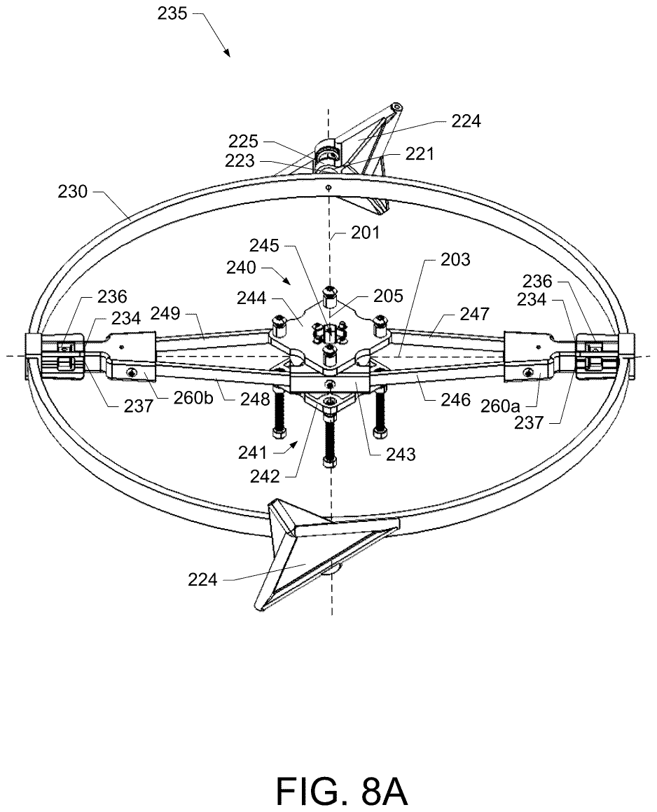

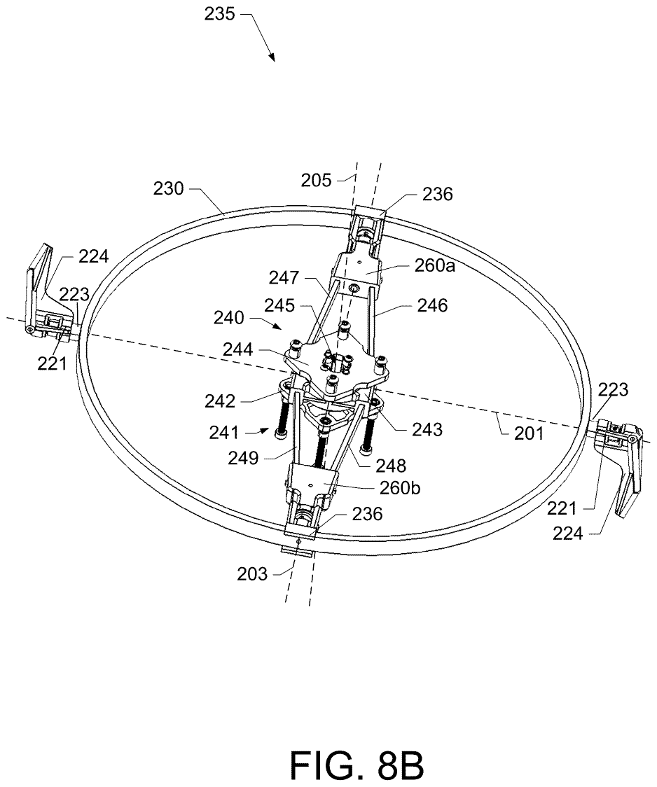

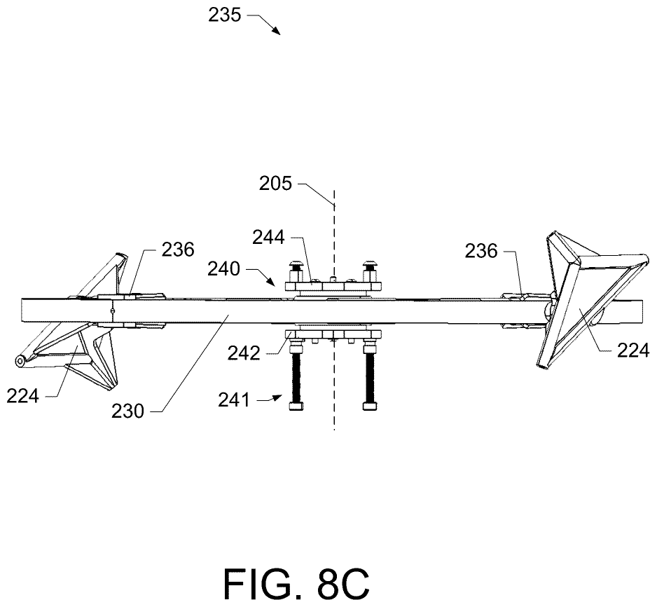

Now referring to FIGS. 8A to 8C, an example embodiment of a three-axis gimbal assembly 235 is shown. In this regard, the gimbal assembly 235 may comprise the cage hubs 224 described with respect to FIGS. 6A and 6B, and the ring hubs 236 described with respect to FIGS. 7A and 7B. Beyond the component of gimbal assembly 296, the gimbal assembly 235 may also comprise a suspension hub 240 and a platform interface 241.

In this regard, a cage hub 224, an axle 223, and an inner hub 221 may be components of respective rotating assembly that function to enable the gimbal ring 230 to rotate about the first axis of rotation 201. As with the gimbal assembly 296, the axles 223 may be operably coupled to respective inner hubs 221 that are affixed to the gimbal ring 230 to support relative rotation about the first axis of rotation 201. Further, the ring hubs 236 and axles 234 may be components of respective rotation assemblies that support relative rotation about the second axis of rotation 203. In this regard, unlike the configuration in gimbal assembly 296, the axles 234 may be coupled to beam connectors 260a or 260b of the suspension hub 240 to facilitate operable coupling and relative rotation about the second axis of rotation 203.

The suspension hub 240 may be operably coupled to the beam connectors 260a and 260b, the beams 246, 247, 248, and 249, an upper plate 244, a rotating member 243, and a lower plate 242, as shown in FIG. 8A. According to some example embodiments, when relative rotation about the second axis of rotation 203 occurs, the suspension hub 240 may rotate relative to the gimbal ring 230. The beam connectors 260 may be configured to support rotation about the second axis of rotation 203 and transition to a dual support beam architecture for the suspension hub 240, as further described below. In this regard, the beam connector 260a may include an axle interface for the axle 234 on one end that, according to some example embodiments, may enable rotation of the axle 234 relative to the beam connector 260a. Further, the beam connector 260a may include a beam interface on an opposite end of the beam connector 260a to couple with beams 246 and 247. The beams 246 and 247 may be coupled between the beam connector 260a and the rotating member 243. Similarly, the beam connector 260b may include an axle interface for the axle 234 on one end that, according to some example embodiments, may enable rotation of the axle 234 relative to the beam connector 260b. Further, the beam connector 260b may include a beam interface on an opposite end of the beam connector 260b to couple with beams 248 and 249. The beams 248 and 249 may be coupled between the beam connector 260b and the rotating member 243.

According to some example embodiments, the suspension hub 240 may be configured to support relative rotation about a third axis of rotation 205. In this regard, the suspension hub 240 may be configured to enable relative rotation between the rotating member 243 and a lower plate 242. The lower plate 242 may include a platform support interface 241, which may be configured to couple the propulsion platform 290 to the lower plate 242, via, for example, bolts or the like. Due to the ability of the lower plate 242 to freely rotate about the third axis of rotation 205 relative to the rotating member 243, the propulsion platform 290 may rotate about the third axis of rotation 205. According to some example embodiments, the suspension hub 240 may also include an upper plate 244 that may be secured to the lower plate 242, through a central channel in the rotating member 243. As a result, the lower plate 242 may be rotationally secured to the rotating member 243 via the upper plate 244, and the lower plate 242 may rotate relative to the rotating member 243. Accordingly, the lower plate 242 may be configured to rotate relative to the rotating member 243 about the third axis of rotation 205. Moreover, the suspension hub 240 may be positioned at an intersection of the first axis of rotation 201 and the second axis of rotation 203, and therefore the third axis of rotation 205 may pass through the intersection of the first axis of rotation 101 and the second axis of rotation 203. According to some example embodiments, the intersection of the first axis of rotation 201 and the second axis of rotation 203 may be, for example, at a centroid of the external cage 250, and thus the suspension hub 240 and the associated rotating assembly may be disposed at the centroid of the external cage 250. As such, three axis relative rotation of the propulsion platform 290 may be realized in this manner, according to some example embodiments.

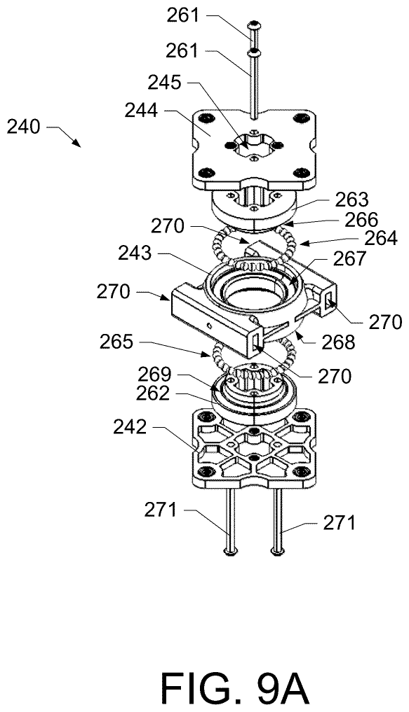

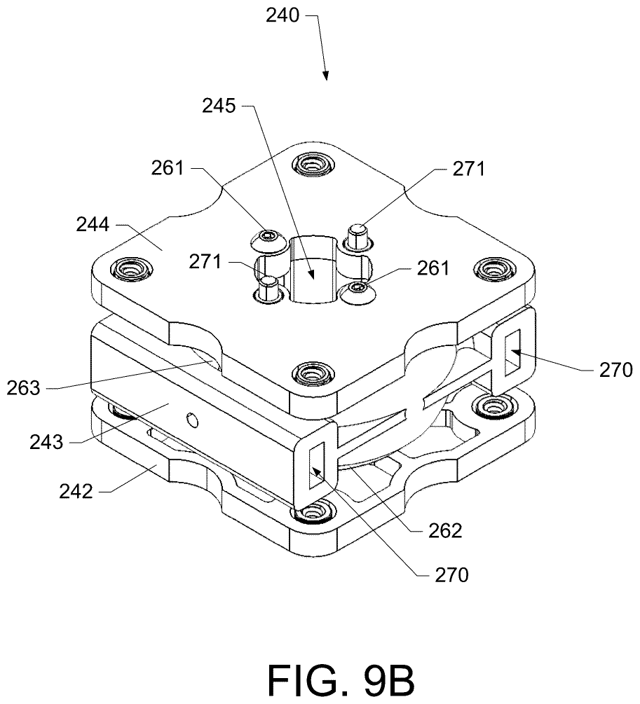

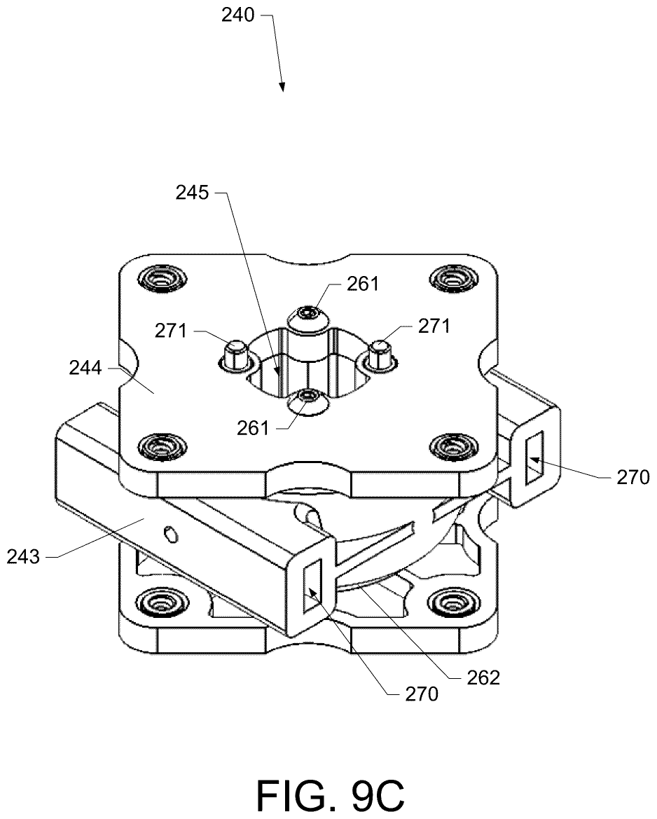

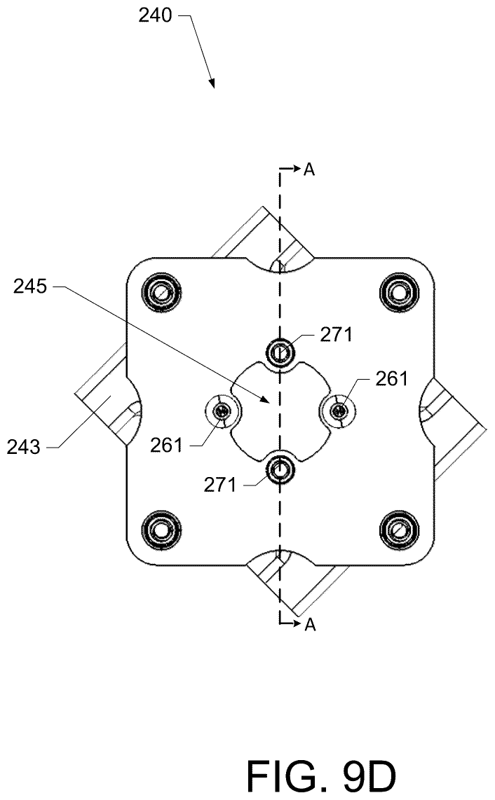

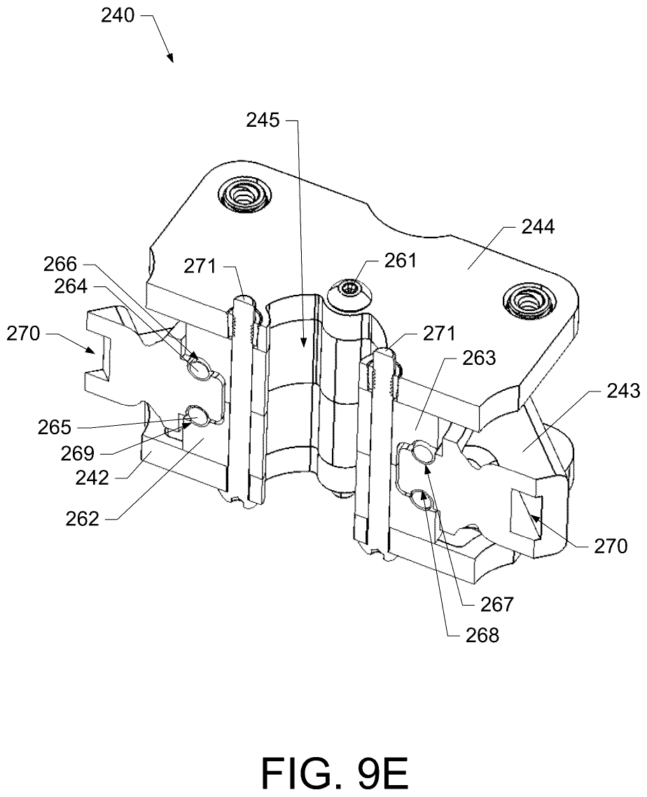

According to some example embodiments, the positioning of the lower plate 242 and the rotating member 243 relative to the positioning of the control circuitry 217 may, for example, inhibit the ability of a GPS receiver of the propulsion platform 290 to receive satellite signals if positioned with the control circuitry 217. As such, according to some example embodiments, the GPS receiver components and any other components that may be affected by the central position of the suspension hub 240 may be placed above the rotating member 243 and supported by the upper plate 244. However, conductors (e.g., wires) that connect from the below the rotating member 243 may be required to connect with the components supported by the upper plate 244. Due to the rotating relative movement, such conductors may need to pass through a centrally located channel to prevent the conductors from wrapping or twisting due to the relative rotation of the rotating member 243. Thus, according to some example embodiments, the upper plate 244, the rotating member 243, and the lower plate 242 may comprise central openings that form a through channel 245 that is centrally located and aligned with third axis of rotation 205. As such, conductors leading from the lower portion of the propulsion platform 290 may pass through the channel 245 for connection to, for example, position circuity disposed on the upper portion of the propulsion platform 290 without risk of wrapping or twisting. Further description of the structure and function of the suspension hub 240 is provided below with respect to FIGS. 9A to 9E.

Additionally, according to some example embodiments, the ring hubs 236 or the beam connectors 260a and 260b may be coupled via a singular beam that extends across the gimbal ring 230 and through the rotating member 243. However, in example embodiments where a channel 245 may be required to support an electrical connection to circuitry on the upper portion of the propulsion platform 290, such a singular beam may be centrally located and may therefore prevent the ability to implement a central channel 245. As such, rather than a singular beam, according to some example embodiments, two beams may be disposed, for example, between the beam connectors 260a and 260b. In this regard, beams 246 and 248 may be portions of a first singular beam that passes through a first connection channel in the rotating member 243, and beams 247 and 249 may be portions of a second singular beam that passes through a second connection channel in the rotating member 243. In this regard, the first beam and the second beam may be separated at the intersection point between the axes of rotation 201, 203, and 205, such that the neither of the first beam and the second passes through the intersection. In other words, the first beam may extend, for example, at an angle that does not intersect with the third axis of rotation, and the second beam may, for example, extend at an angle that also does not intersect with the third axis of rotation. As a result, the channel 245 may be implemented without being hindered by a beam passing through the channel 245. According to some example embodiments, the first beam and the second beam may be spaced apart and parallel or the first beam and the second beam may extend along a non-linear path between the beam connectors 260a and 260b. In this regard, the distance between the first beam and the second beam may increase from their connection to a beam connector 260 and increase over the length of the first beam and the second beam to reach a maximum distance between the first beam and the second beam adjacent to the intersection of the axes of rotation to avoid the channel 245. Moreover, the first beam and the second beam may be spread apart at the intersection of the axes of rotation, to avoid intersection with the channel 245.

Now referring to FIG. 9A, an exploded view of the components of the suspension hub 240 is shown according to some example embodiments. In this regard, the suspension hub 240 may comprise an upper plate 244, an upper race member 263, upper balls 264, the rotating member 243, lower balls 265, a lower race member 262, and a lower plate 242. As indicated in FIG. 9A, the upper plate 244 may be coupled to various other components of the suspension hub 240 via pins 261. In this regard, the pins 261 may extend through respective holes in the upper plate 244, the upper race member 263, the lower race member 262, and into cavities, e.g., threaded cavities, in the lower plate 242 to secure the components of the suspension hub 240 together. Similarly, the pins 271 may extend through respective holes in the lower plate 242, the lower race member 262, the upper race member 263, and into cavities, e.g., threaded cavities, in the upper plate 244 to further secure the components of the suspension hub 240 together.

The rotating member 243 may comprise slots 270 for receiving, for example, beams that are operably coupled to, for example, the beam connectors 260a and 260b. According to some example embodiments, the slots 270 on a common side of the rotating member 243 may be connected such that those slots 270 form a beam channel through the rotating member 243. Accordingly, the rotating member 243 may comprise two such beam channels.

Additionally, the rotating member 243 may be configured to be a component of two ball bearing assemblies that are configured to reduce the friction of relative rotation permitted by the suspension hub 240. In this regard, according to some example embodiments, the rotating member 243 may comprise a race groove 267 and a race groove 268. The race groove 267 may be a circular groove on an upper or top side of the rotating member 243 configured to interface with the upper balls 264 as an outer support for the upper balls 264. The upper race member 263 may also comprise a race groove 266 which may be a circular-shaped groove that is configured to interface with the upper balls 264 as an inner support for the upper balls 264. According to some example embodiments, the upper race member 263 may be affixed to or integrated with the upper plate 244. Similarly, the race groove 267 may be a circular groove on a lower or bottom side of the rotating member 243 configured to interface with the lower balls 265 as an outer support for the lower balls 265. The lower race member 262 may also comprise a race groove 269 which may be a circular-shaped groove that is configured to interface with the lower balls 265 as an inner support for the lower balls 265. According to some example embodiments, the lower race member 262 may be affixed to or integrated with the lower plate 242. Additionally, each of the upper plate 244, the upper race member 263, the rotating member 243, the lower race member 262, and the lower plate 242 may comprise a central opening that are aligned to form the central channel 245.

FIGS. 9B to 9D show the example embodiment of the suspension hub 240 in an assembled configuration. In this regard, as shown in FIG. 9B, the pins 271 and 261 may pass through the upper plate 244, the upper race member 263, the rotating member 243, the lower race member 262, and the lower plate 242 to secure the suspension hub 240 together as a component that facilitates relative rotational movement of the propulsion platform 290 relative to the external cage 250. To illustrate the rotating functionality of the suspension hub 240, FIG. 9B shows the rotating member 243 in a first position and FIGS. 9C and 9D illustrate the rotating member 243 in a forty-five degree rotated position from the first position.

FIG. 9E illustrates a cross-section perspective view of the suspension hub 240 and the central channel 245. In this regard, as can be seen in FIG. 9E, the upper race member 263 and the lower race member 262 may be in direct contact in an interior of the suspension hub 240 to define a portion of the central channel 245. In this regard, the rotating member 243 may be positioned as an external component such that the rotating movement of the rotating member 243 is not present within the central channel 245. Further, the central channel 245, as shown, extends from the upper plate 244 to the lower plate 242.

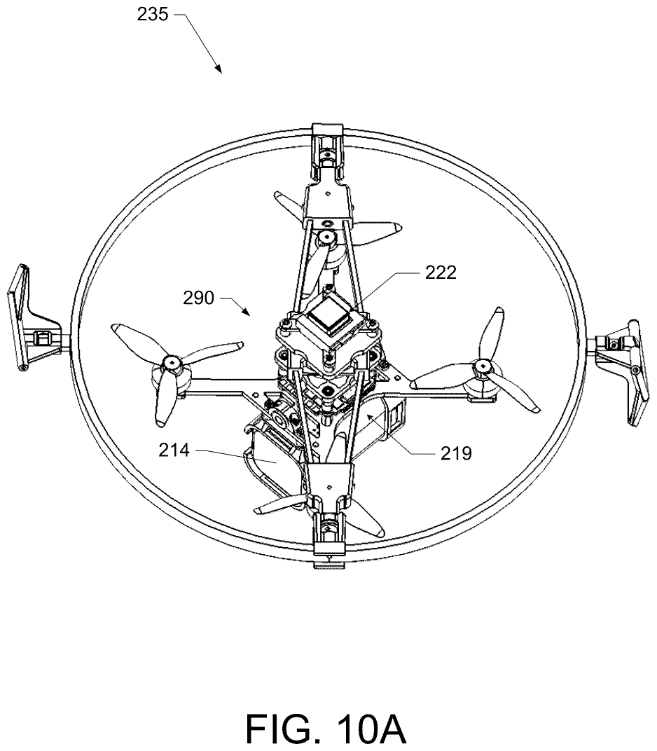

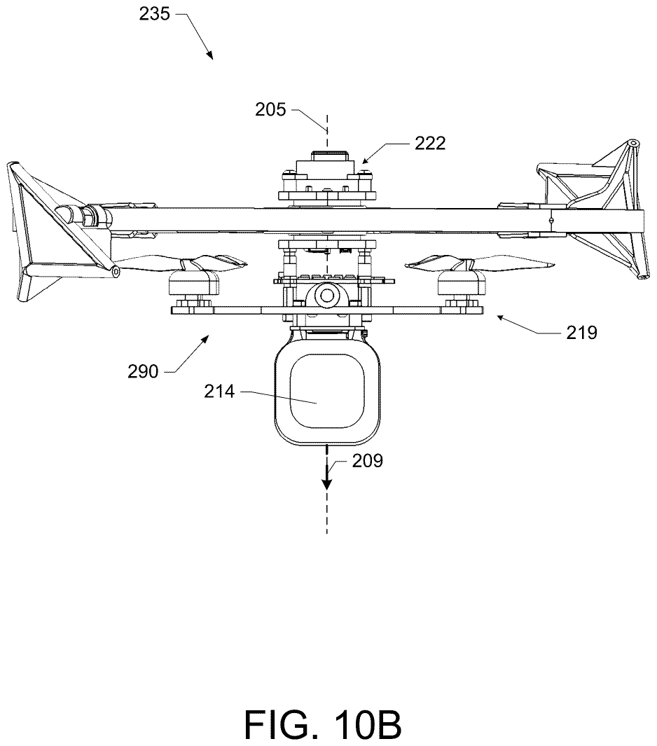

Having described various aspects of the propulsion platform 290, the external cage 250, and the gimbal assembly 235, FIGS. 10A and 10B illustrate an assembly comprising the propulsion platform 290 and the gimbal assembly 235, in isolation from the external cage 250. In this regard, the propulsion platform 290, with its lower portion 219 and its upper portion 222, may be coupled to the three axis gimbal assembly 235. More specifically, the propulsion platform 290 may be coupled to the suspension hub 240 via a platform interface that secures the propulsion platform 290 to the lower plate 242 such that rotation of the lower plate 242 around the third axis of rotation 205 also rotates the propulsion platform 290. Additionally, according to some example embodiments, the propulsion platform 290 may be able to rotate relative to the external cage 250 in accordance with the first and second axes of rotation described herein. Having described various example embodiments, the following is provided to expressly describe some specific examples and combinations of examples. It is understood that the following merely provides some examples and combination and is not to be considered exhaustive of all example embodiments.

In a first example embodiment an aerial vehicle is provided. The aerial vehicle may comprise an aeronautic platform, an external cage, and a gimbal assembly. The aeronautic platform may comprise a body, a motor supported by the body, and an aeronautic propeller operably coupled to the motor. The motor may be controllable to control rotation of the propeller. The external cage may be operably coupled to the aeronautic platform. The external cage may comprise a plurality of rods connected by a plurality of vertex connectors. The aeronautic platform may be disposed within the external cage. The gimbal assembly may operably couple the aeronautic platform to the external cage and enable relative rotational movement between the aeronautic platform and the external cage about a first axis of rotation.

For a second example embodiment, that is a modification to the first example embodiment, the gimbal assembly may comprise a first rotating assembly and a second rotating assembly. The first rotating assembly may comprise a first axle operably coupled to the external cage in alignment with the first axis of rotation. The second rotating assembly may comprise a second axle operably coupled to the external cage in alignment with the first axis of rotation.

For a third example embodiment, that is a modification to the second example embodiment, the gimbal assembly may further comprise a gimbal ring coupled to the external cage via the first rotating assembly and the second rotating assembly. The gimbal assembly may further comprise a third rotating assembly and a fourth rotating assembly. The third rotating assembly may comprise a third axle operably coupled to the gimbal ring in alignment with a second axis of rotation to enable the gimbal ring to rotate about the second axis of rotation relative to the external cage. The fourth rotating assembly may comprise a fourth axle operably coupled to the gimbal ring in alignment with the second axis of rotation to enable the gimbal ring to rotate about the second axis of rotation relative to the external cage. The second axis of rotation may be perpendicular to the first axis of rotation.

For a fourth example embodiment, that is a modification of the third example embodiment, the gimbal assembly may further comprise a fifth rotating assembly that is coupled to the third rotating assembly and the fourth rotating assembly. The fifth rotating assembly may also be coupled to the aeronautic platform such that the fifth rotating assembly enables the aeronautic platform to rotate about a third axis of rotation that is perpendicular to the first axis of rotation and the second axis of rotation.

For a fifth example embodiment, that is a modification of the fourth example embodiment, the gimbal assembly may be a passive gimbal that enables the external cage to freely rotate relative to the aeronautic platform about the first axis of rotation, the second axis of rotation, and the third axis of rotation.

For a sixth example embodiment, that is a modification of the fifth example embodiment, a center of gravity of the aeronautic platform may be offset from an intersection of the first axis of rotation and the second axis of rotation to cause a bottom face of the aeronautic platform to be predictably oriented towards a ground surface due to gravity.

For a seventh example embodiment, that may be a modification of the fifth or sixth example embodiments, the fifth rotating assembly may be positioned at a centroid of the external cage and at an intersection of the first axis of rotation, the second axis of rotation, and the third axis of rotation.

For an eighth example embodiment, that may be a modification of the seventh example embodiment, the fifth rotating assembly may comprise an interior channel. A first portion of the aeronautic platform may be affixed to a first side of the fifth rotating assembly. A second portion of the aeronautic platform may be affixed to a second side of the fifth rotating assembly. The first side may be opposite the second side. Conductors from the second portion may pass through the interior channel to the first portion and may be unaffected by rotation of the aeronautic platform about the third axis of the rotation.

For a ninth example embodiment, that may be a modification of the eighth example embodiment, the aeronautic platform may comprise a battery and a position sensor. The position sensor may be disposed on the second portion and the battery may be disposed on the first portion.

For a tenth example embodiment, that may be a modification of any of the seventh to ninth example embodiments, the gimbal assembly may comprise a plurality of beams, and the plurality of beams may comprise a first beam and a second beam. The first beam may extend from the third rotating assembly to the fifth rotating assembly at an angle that does not intersect with the third axis of rotation. The second beam may extend from the fourth rotating assembly to the fifth rotating assembly at an angle that does not intersect with the third axis of rotation.

According to some example embodiments, an eleventh example embodiment is provided as a barrier assembly for suspending a propulsion platform therein, such that the barrier assembly is freely rotatable relative to the propulsion platform about at least a first axis of rotation. The barrier assembly may comprise a plurality of rods and a plurality of vertex connectors. The plurality of rods may be connected by the plurality of vertex connectors to form an external cage having a shape. The external cage may be configured to maintain the propulsion platform within an internal volume of the external cage. The barrier assembly may further comprise a gimbal assembly configured to operably couple the external cage to the propulsion platform in a secured position while enabling relative rotational movement between the propulsion platform and the external cage about the first axis of rotation.

For a twelfth example embodiment, that is modification of the eleventh example embodiment, the gimbal assembly may comprise a gimbal ring, a first rotating assembly coupled between the external cage and the gimbal ring to enable rotation of the propulsion platform relative to the external cage about the first axis of rotation, a second rotating assembly coupled between the external cage and the gimbal ring to enable rotation of the propulsion platform relative to the external cage about the first axis of rotation, a third rotating assembly coupled to the gimbal ring and configured to be operably coupled to the propulsion platform to enable rotation of the propulsion platform relative to the external cage about a second axis of rotation, and a fourth rotating assembly coupled to the gimbal ring and configured to be operably coupled to the propulsion platform to enable rotation of the propulsion platform relative to the external cage about the second axis of rotation. The second axis of rotation may be perpendicular to the first axis of rotation.

For a thirteenth example embodiment, that is a modification of any of the eleventh or twelfth example embodiments, the plurality of rods and the plurality of vertex connectors may be connected in a pattern that comprises a plurality of polygons formed by the rods and the vertex connectors. Each polygon within the plurality of polygons may be defined by a plurality of coplanar vertices.

For a fourteenth example embodiment, that is a modification of any of the eleventh to thirteenth example embodiments, the plurality of rods and the plurality of vertex connectors may be connected in a pattern that comprises hexagons and pentagons formed by the rods and the vertex connectors.

For a fifteenth example embodiment, that is a modification of any of the eleventh to fourteenth example embodiments, one or more connections between one of the rods of the plurality of rods, and one of the vertex connectors of the plurality of vertex connectors is removable to facilitate disassembly, maintenance, storage, and subsequent reassembly of the external cage.

For a sixteenth example embodiment, that is a modification of any of the eleventh to fifteenth example embodiments, each of the vertex connectors of the plurality of vertex connectors comprises an elastic material that causes the external cage to have elasticity to temporarily deform in response to an impact with the external cage.

For a seventeenth example embodiment, that is a modification of the sixteenth example embodiment, each of the rods of the plurality of rods is rigid.

For an eighteenth example embodiment, that is a modification of the sixteenth or seventeenth example embodiment, each of the plurality of rods comprise carbon fiber, fiber glass reinforced plastic, or metal.

For a nineteenth example embodiment, that is a modification of any of the eleventh to eighteenth example embodiments, a center of gravity of the external cage may be offset from a centroid of the external cage such that a weighted region of the external cage is maintained at a bottom position due to gravity.

A twentieth example embodiment that is a vehicle is also provided. The vehicle may comprise a propulsion platform, an external cage, and a gimbal assembly. The propulsion platform may comprise a body, a motor supported by the body, and a propeller operably coupled to the motor. The motor may be controllable to control rotation of the propeller. An external cage may be operably coupled to the propulsion platform. The external cage may comprise a plurality of rods connected by a plurality of vertex connectors. The propulsion platform may be disposed within the external cage. The gimbal assembly may operably couple the propulsion platform to the external cage thereby securing the propulsion platform to the external cage while enabling relative rotational movement between the propulsion platform and the external cage about a first axis of rotation, a second axis of rotation, and a third axis of rotation. The first axis of rotation, the second axis of rotation, and the third axis of rotation may each be perpendicular to each other.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

1. An aerial vehicle comprising:
an aeronautic platform comprising:
a body;
a motor supported by the body; and
an aeronautic propeller operably coupled to the motor, wherein the motor is controllable to control rotation of the propeller;
an external cage operably coupled to the aeronautic platform, the external cage comprising a plurality of rods connected by a plurality of vertex connectors, wherein the aeronautic platform is disposed within the external cage; and
a gimbal assembly that operably couples the aeronautic platform to the external cage and enables relative rotational movement between the aeronautic platform and the external cage about a first axis of rotation.

2. The aerial vehicle of claim 1, wherein the gimbal assembly comprises a first rotating assembly and a second rotating assembly;
wherein the first rotating assembly comprises a first axle operably coupled to the external cage in alignment with the first axis of rotation;
wherein the second rotating assembly comprises a second axle operably coupled to the external cage in alignment with the first axis of rotation.

3. The aerial vehicle of claim 2, wherein the gimbal assembly further comprises a gimbal ring coupled to the external cage via the first rotating assembly and the second rotating assembly;
wherein the gimbal assembly further comprises a third rotating assembly and a fourth rotating assembly;
wherein the third rotating assembly comprises a third axle operably coupled to the gimbal ring in alignment with a second axis of rotation to enable the gimbal ring to rotate about the second axis of rotation relative to the external cage;
wherein the fourth rotating assembly comprises a fourth axle operably coupled to the gimbal ring in alignment with the second axis of rotation to enable the gimbal ring to rotate about the second axis of rotation relative to the external cage;
wherein the second axis of rotation is perpendicular to the first axis of rotation.

4. The aerial vehicle of claim 3, wherein the gimbal assembly further comprises a fifth rotating assembly that is coupled to the third rotating assembly and the fourth rotating assembly;
wherein the fifth rotating assembly is also coupled to the aeronautic platform such that the fifth rotating assembly enables the aeronautic platform to rotate about a third axis of rotation that is perpendicular to the first axis of rotation and the second axis of rotation.

5. The aerial vehicle of claim 4, wherein the gimbal assembly is a passive gimbal that enables the external cage to freely rotate relative to the aeronautic platform about the first axis of rotation, the second axis of rotation, and the third axis of rotation.

6. The aerial vehicle of claim 5, wherein a center of gravity of the aeronautic platform is offset from an intersection of the first axis of rotation and the second axis of rotation to cause a bottom face of the aeronautic platform to be predictably oriented towards a ground surface due to gravity.

7. The aerial vehicle of claim 5, wherein the fifth rotating assembly is positioned at a centroid of the external cage and at an intersection of the first axis of rotation, the second axis of rotation, and the third axis of rotation.

8. The aerial vehicle of claim 7, wherein the fifth rotating assembly comprises an interior channel;
wherein a first portion of the aeronautic platform is affixed to a first side of the fifth rotating assembly;
wherein a second portion of the aeronautic platform is affixed to a second side of the fifth rotating assembly, the first side being opposite the second side;
wherein conductors from the second portion pass through the interior channel to the first portion and are unaffected by rotation of the aeronautic platform about the third axis of the rotation.

9. The aerial vehicle of claim 8, wherein the aeronautic platform comprises a battery and a position sensor;
wherein the position sensor is disposed on the second portion and the battery is disposed on the first portion.

10. The aerial vehicle of claim 7, wherein the gimbal assembly comprises a plurality of beams comprising a first beam and a second beam;
wherein the first beam extends from the third rotating assembly to the fifth rotating assembly at an angle that does not intersect with the third axis of rotation;
wherein the second beam extends from the fourth rotating assembly to the fifth rotating assembly at an angle that does not intersect with the third axis of rotation.

11. A barrier assembly for suspending a propulsion platform therein such that the barrier assembly is freely rotatable relative to the propulsion platform about at least a first axis of rotation, the barrier assembly comprising:
a plurality of rods;
a plurality of vertex connectors, the plurality of rods being connected by the plurality of vertex connectors to form an external cage having a shape, wherein the external cage is configured to maintain the propulsion platform within an internal volume of the external cage; and
a gimbal assembly configured to operably couple the external cage to the propulsion platform in a secured position while enabling relative rotational movement between the propulsion platform and the external cage about the first axis of rotation.

12. The barrier assembly of claim 11, wherein the gimbal assembly comprises:
a gimbal ring;
a first rotating assembly coupled between the external cage and the gimbal ring to enable rotation of the propulsion platform relative to the external cage about the first axis of rotation;
a second rotating assembly coupled between the external cage and the gimbal ring to enable rotation of the propulsion platform relative to the external cage about the first axis of rotation;
a third rotating assembly coupled to the gimbal ring and configured to be operably coupled to the propulsion platform for rotation of the propulsion platform relative to the external cage about a second axis of rotation; and
a fourth rotating assembly coupled to the gimbal ring and configured to be operably coupled to the propulsion platform to enable rotation of the propulsion platform relative to the external cage about the second axis of rotation;
wherein the second axis of rotation is perpendicular to the first axis of rotation.

13. The barrier assembly of claim 11, wherein the plurality of rods and the plurality of vertex connectors are connected in a pattern that comprises a plurality of polygons formed by the rods and the vertex connectors, wherein each polygon within the plurality of polygons is defined by a plurality of coplanar vertices.

14. The barrier assembly of claim 11, wherein the plurality of rods and the plurality of vertex connectors are connected in a pattern that comprises hexagons and pentagons formed by the rods and the vertex connectors.

15. The barrier assembly of claim 11, wherein one or more connections between one of the rods of the plurality of rods and one of the vertex connectors of the plurality of vertex connectors is removable to facilitate disassembly, maintenance, storage, and subsequent reassembly of the external cage.

16. The barrier assembly of claim 11, wherein each of the vertex connectors of the plurality of vertex connectors comprises an elastic material that causes the external cage to have elasticity to temporarily deform in response to an impact with the external cage.

17. The barrier assembly of claim 16, wherein each of the rods of the plurality of rods is rigid.

18. The barrier assembly of claim 16, wherein each of the plurality of rods comprise carbon fiber, fiber glass reinforced plastic, or metal.

19. The barrier assembly of claim 11, wherein a center of gravity of the external cage is offset from a centroid of the external cage such that a weighted region of the external cage is maintained at a bottom position due to gravity.

20. A vehicle comprising:
a propulsion platform, the propulsion platform comprising:
a body;
a motor supported by the body; and
a propeller operably coupled to the motor, wherein the motor is controllable to control rotation of the propeller;
an external cage operably coupled to the propulsion platform, the external cage comprising a plurality of rods connected by a plurality of vertex connectors, wherein the propulsion platform is disposed within the external cage; and
a gimbal assembly that operably couples the propulsion platform to the external cage thereby securing the propulsion platform to the external cage while enabling relative rotational movement between the propulsion platform and the external cage about a first axis of rotation, a second axis of rotation, and a third axis of rotation;
wherein the first axis of rotation, the second axis of rotation, and the third axis of rotation are each perpendicular to each other.
